(19) United States
(12) Patent Application Publication
(10) Pub. No.: US 2024/0170717 A1
(43) Pub. Date: May 23, 2024

(54) MULTI-LAYER CERAMIC BATTERIES INCLUDING ALL-SOLID ELECTROLYTE AND ELECTRONIC APPARATUSES INCLUDING THE MULTI-LAYER CERAMIC BATTERIES

(71) Applicant: Samsung Electronics Co., Ltd., Suwon-si (KR)

(72) Inventors: Heungchan Lee, Suwon-si (KR); Jonghoon Ka, Suwon-si (KR); Sungjin Lim, Suwon-si (KR)

(21) Appl. No.: 18/388,669

(22) Filed: Nov. 10, 2023

(30) Foreign Application Priority Data
Nov. 17, 2022 (KR) 10-2022-0154875

(51) Int. Cl. H01M 10/0562; H01M 4/66

(52) U.S. Cl. CPC H01M 10/0562; H01M 4/667; H01M 2220/30

(57) ABSTRACT

A multi-layer ceramic battery including a main region in which charging and discharging is performed, a peripheral region positioned around the main region, and a plurality of outer current collector layers disposed on a side surface of the peripheral region, wherein each outer current collector layer of the plurality of outer current collector layers is spaced apart from one other, wherein the peripheral region includes a stack, which includes at least three side surfaces, is in contact with the outer current collector layers, and is connected to the main region, and the plurality of outer current collector layers is disposed on the at least three side surfaces.

### CROSS-REFERENCE TO RELATED APPLICATION

This application claims priority to and the benefit of Korean Patent Application No. 10-2022-0154875, filed on Nov. 17, 2022, in the Korean Intellectual Property Office, and all the benefits accruing therefrom under 35 U.S.C. § 119, the content of which in its entirety is herein incorporated by reference.

### BACKGROUND

### 1. Field

The disclosure relates to secondary batteries and, more specifically, to multi-layer ceramic batteries including an all-solid electrolyte and electronic apparatuses including the multi-layer ceramic batteries.

### 2. Description of Related Art

A multi-layer ceramic battery (MLCB) may be considered as a battery version of a multi-layer ceramic capacitor (MLCC). The MLCB may be considered as having a structure in which a thin film oxide electrode and an oxide electrolyte are alternately arranged and stacked.

The MLCB is based on the MLCC structure so far, and research has been conducted on performance degradation caused by fast charge or discharge and current imbalance.

### SUMMARY

Embodiments provide multi-layer ceramic batteries including an all-solid electrolyte capable of widening a current collecting area.

Embodiments provide multi-layer ceramic batteries including an all-solid electrolyte capable of preventing the current density from increasing in a specific area.

Embodiments provide electronic apparatuses including the multi-layer ceramic batteries.

Additional aspects will be set forth in part in the description which follows and, in part, will be apparent from the description, or may be learned by practice of the presented embodiments of the disclosure.

Disclosed is a multi-layer ceramic battery including: a main region in which charging and discharging is performed, a peripheral region positioned around the main region, and a plurality of outer current collector layers disposed on a side surface of the peripheral region, wherein each outer current collector layer of the plurality of outer current collector layers is spaced apart from one another, wherein the peripheral region includes a stack, which includes at least three side surfaces, is in contact with the outer current collector layers, and is connected to the main region, and the plurality of outer current collector layers is disposed on the at least three side surfaces.

In an embodiment, the plurality of outer current collector layers may include a first outer current collector layer; and a second outer current collector layer spaced apart from the first outer current collector layer, wherein the first outer current collector layer may be disposed on at least one of the at least three side surfaces, and the second outer current collector layer may be disposed on remaining side surfaces of the at least three side surfaces. The plurality of outer current collector layers may be symmetrical or asymmetrical with respect to the main region.

In an embodiment, the peripheral region may be symmetrical or asymmetrical with respect to the main region.

In an embodiment, the main region may include a first electrode layer, a second electrode layer facing the first electrode layer, and an all-solid electrolyte layer disposed between the first electrode layer and the second electrode layer.

In an embodiment, the peripheral region may include a first peripheral region including the first electrode layer and the all-solid electrolyte layer, and not including the second electrode layer, and a second peripheral region including the second electrode layer and the all-solid electrolyte layer, and not including the first electrode layer, wherein the first and the second peripheral regions may be spaced apart from each other.

In an embodiment, the first and the second peripheral regions may be located on a same side of the main region and may be spaced apart from each other.

In an embodiment, at least one of the first electrode layer and the second electrode layer may include a part, which extends to the peripheral region in three different directions.

In an embodiment, a second part of the first electrode layer may extend in three different directions, and a second part the second electrode layer may extend in three different directions, and the first electrode layer and the second electrode layer may be bilaterally symmetrical to each other in a plan view.

In an embodiment, a first part of the first electrode layer may extend in four different directions, and a first part of the second electrode layer may extend in four different directions, and the first electrode layer and the second electrode layer may be bilaterally symmetrical to each other in a plan view.

In an embodiment, a first inner current collector layer connected to one of an outer current collector layer of the plurality of outer current collector layers may be further disposed on a first surface of one of the first or the second electrode layers. In an embodiment, a second inner current collector layer connected to an other outer current collector layer of the plurality of outer current collector layers may be further disposed on a second surface of an other of the first or the second electrode layers.

In an embodiment, a first inner current collector layer connected to one of an outer current collector layer of the plurality of outer current collector layers may be further included, and one of the first or the second electrode layers may be disposed on both surfaces of the first inner current collector layer. A second inner current collector layer connected to an other outer current collector layer of the plurality of outer current collector layers may be further included, and an other of the first or the second electrode layers may be disposed on both surfaces of the second inner current collector layer.

Disclosed is an electronic device including a battery, and a control unit configured to control an operation of the electronic device, wherein the battery includes the multi-layer ceramic battery. In an embodiment, the electronic device may include a wearable device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a plan view of an embodiment of a first multi-layer ceramic battery including an all-solid electrolyte;

FIG. 2 is a cross-sectional view of the first multi-layer ceramic battery of FIG. 1 taken along line 2-2′ of FIG. 1;

FIG. 3 is a cross-sectional view of the first multi-layer ceramic battery of FIG. 1 taken along line 3-3′ of FIG. 1;

FIG. 4 is a plan view of an embodiment of a second multi-layer ceramic battery including an all-solid electrolyte;

FIG. 5 is a cross-sectional view of the second multi-layer ceramic battery of FIG. 4 taken along line 5-5′ of FIG. 4;

FIG. 6A is a plan view of a first electrode layer of the second multi-layer ceramic battery of FIG. 4;

FIG. 6B is a plan view of a second electrode layer of the second stacked multi-layer ceramic battery of FIG. 4;

FIG. 7 is a plan view of an embodiment of a third multi-layer ceramic battery including an all-solid electrolyte;

FIG. 8 is a cross-sectional view of the third multi-layer ceramic battery of FIG. 7 taken along line 8-8′ of FIG. 7;

FIG. 9 is a cross-sectional view of the third multi-layer ceramic battery of FIG. 7 taken along line 9-9′ of FIG. 7;

FIG. 10 is a plan view of an embodiment of a fourth multi-layer ceramic battery including an all-solid electrolyte;

FIG. 11 is a cross-sectional view of the fourth multi-layer ceramic battery of FIG. 10 taken along line 11-11′ of FIG. 10;

FIG. 12 is a cross-sectional view of the fourth multi-layer ceramic battery of FIG. 10 taken along line 12-12′ of FIG. 10;

FIG. 13 is a plan view of an embodiment of a fifth multi-layer ceramic battery including an all-solid electrolyte;

FIG. 14 is a cross-sectional view of the fifth multi-layer ceramic battery of FIG. 13 taken along line 14-14′ of FIG. 13;

FIG. 15 is a cross-sectional view of the fifth multi-layer ceramic battery of FIG. 13 taken along line 15-15′ of FIG. 13;

FIG. 16A is a plan view of a first electrode layer of the fifth multi-layer ceramic battery of FIG. 13;

FIG. 16B is a plan view of a second electrode layer of the fifth multi-layer ceramic battery of FIG. 13;

FIGS. 17 and 18 are each a plan view of a modified example of the fifth multi-layer ceramic battery of FIG. 13;

FIGS. 19 and 20 are each a cross-sectional view of an embodiment of a modified example of a unit battery included in a multi-layer ceramic battery including an all-solid electrolyte;

FIG. 21 is a plan view of an embodiment of a sixth multi-layer ceramic battery including an all-solid electrolyte;

FIG. 22 is a plan view of an embodiment of a seventh multi-layer ceramic battery including an all-solid electrolyte;

FIG. 23 is a plan view of an embodiment of an eighth multi-layer ceramic battery including an all-solid electrolyte;

FIG. 24 is a perspective view of an embodiment of a battery-replaceable wireless earbuds as an example of an electronic device including a secondary battery;

FIG. 25 is a perspective view of a case for wired or wireless use of the earbud of FIG. 24;

FIG. 26 is a perspective view of a case in which the earbud of FIG. 24 is for a battery-embedded type that does not have a slot;

FIG. 27 is a perspective view of a case for storing and charging the battery replacement earbuds; and

FIG. 28 is a perspective view of a mobile device for the earbuds illustrated in FIG. 24.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

Hereinafter, a multi-layer ceramic battery including an all-solid electrolyte and an electronic apparatus including the same according to an embodiment will be described in detail with reference to the accompanying drawings. In the following description, the thicknesses of the layers or regions shown in the drawings may be somewhat exaggerated for clarity of the specification.

The embodiments described below are merely examples and various modifications are possible from these embodiments. Further, in the disclosure of the layer structure, the expressions referred to as “upper portion” or “on” may be referred to an being in contact directly, as well as being one above another in non-contact. In the following description, like reference numerals refer to like elements in each drawing.

The singular expression includes plural expressions unless the context clearly implies otherwise. In addition, when a part “includes” a component, this means that it may further include other components, not excluding other components unless otherwise opposed.

The use of the term “the” and similar indicative terms may correspond to both singular and plural. If there is no explicit description or contrary description of the order of the steps or operations constituting the method, these steps or operations may be carried out in an appropriate order. The steps or operations are not necessarily limited to the order of description of the steps or operations.

Further, the terms “unit”, “module” or the like mean a unit that processes at least one function or operation, which may be implemented in hardware or software or implemented in a combination of hardware and software.

The connection or connection members of lines between the components shown in the drawings exemplarily represent functional connection and/or physical or circuit connections, and may be replaceable or represented as various additional functional connections, physical connections, or circuit connections in an actual device.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value. Endpoints of ranges may each be independently selected.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The use of all examples or exemplary terms is merely for describing a technical idea in detail and the scope is not limited to the examples or exemplary terms unless limited by the claims.

“Multi-layer ceramic batteries” or “stacked batteries” are batteries in which two or more unit batteries (i.e., unit cells) are stacked sequentially in a first direction. In an embodiment, the number of unit batteries stacked in the first direction may be several, dozens, or hundreds, but is not limited thereto. When a plurality of unit batteries is stacked on a first surface of a base substrate in a direction perpendicular to or substantially perpendicular to the first surface of the base substrate, the first direction may be a direction perpendicular to the first surface of the base substrate. The unit battery may be represented as a battery of a minimum size capable of performing a battery operation. In an embodiment, the unit battery may have a layer structure in which a first electrode layer, an all-solid electrolyte layer, and a second electrode layer are sequentially stacked. One of the first and second electrode layers may be a cathode layer, and the other may be an anode layer. In an embodiment, a material of the cathode layer may include a lithium active material and a sodium active material, such as lithium cobalt oxide (LCO), lithium manganese oxide (LMO), lithium manganese nickel oxide (LMNO), nickel cobalt manganese (NCM), nickel cobalt aluminum (NCA), or lithium vanadium phosphate (LVP). In an embodiment, the material of the anode layer may include silicon (Si), carbon (C), graphite, LVP, lithium titanate oxide (LTO), lithium, or silver, but is not limited thereto. In an embodiment, the anode layer may not comprise an anode upon assembly, for example, the anode layer may not include the materials described above and may include only a current collector layer upon assembly. In an embodiment, the material of the all-solid electrolyte layer may include lanthanum barium tin oxide (LBSO), lithium aluminum titanate phosphate (LATP), lithium aluminum germanium phosphate (LAGP), lithium lanthanum titanium oxide (LLTO), lithium lanthanum zirconium oxide (LLZO), lithium lanthanum zirconium tantalum oxide (LLZTO), or halide derivatives, but is not limited thereto. In an embodiment, a planar shape of the first electrode layer and a planar shape of the second electrode layer may be the same or different from each other. In an embodiment, areas of the first and second electrode layers in a plan view may be the same as or different from each other. In an embodiment, the perimeter (e.g., circumference, or edge) of the first and second electrode layers in a plan view may include a curve, a curve and a straight line, or a plurality of straight lines parallel to or angled to each other. In an embodiment, shapes of the first and second electrode layers in a plan view may be circular, non-circular, or polygonal.

In an embodiment, a number of side surfaces of the first electrode layer and a number of side surfaces of the second electrode layer may be the same as or different from each other. In an embodiment, each of the first and second electrode layers may include at least three side surfaces.

Thus, a multi-layer ceramic battery including such a unit battery may include three or more side surfaces (at least three side surfaces) to which an outer current collector may be attached or contacted, and may have a structure in which at least three side surfaces are covered with an outer current collector. The at least three side surfaces may be in different directions on the same plane. In an embodiment, the multi-layer ceramic battery may have a structure including at least four side surfaces facing different directions on the same plane, at least one of the four side surfaces may be covered with a first outer current collector (e.g., a cathode outer current collector), and remaining side surfaces may be covered with a second outer current collector (e.g., an anode outer current collector). In an embodiment, the multi-layer ceramic battery may have a form including at least five side surfaces, at least one of the five side surfaces may be covered with a first outer current collector, and remaining side surfaces may be covered with a second outer current collector. In an embodiment, a material of the outer current collector may be copper, aluminum, iron, an alloy including copper, aluminum, iron, a conductive oxide, such as ITO or FTO, or a combination thereof, but is not limited thereto.

The outer current collector is provided on at least three side surfaces of the multi-layer ceramic battery to increase an area of the current collector, thereby solving or minimizing a problem (e.g., degradation) caused by concentration of current in a specific region or a narrow region during charging and discharging, and thus ensuring stability of the battery and reducing a charging time. Thus, high-speed charging may be possible.

In an embodiment, a shape or a size of the outer current collector provided on the side surface of the multi-layer ceramic battery may vary depending on the conductivity of the anode layer and the cathode layer included in the multi-layer ceramic battery. In an embodiment, a separate inner current collector connected to the outer current collector may or may not be provided depending on the conductivity of the anode layer and the cathode layer of the multi-layer ceramic battery.

Hereinafter, these multi-layer ceramic batteries will be described in more detail through embodiments.

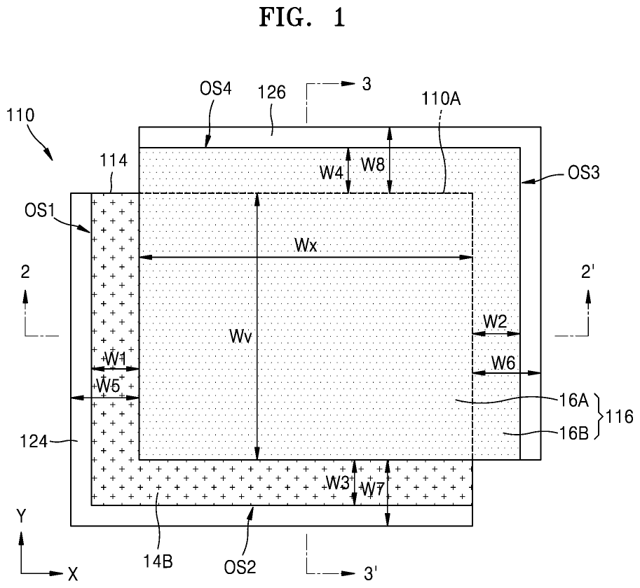

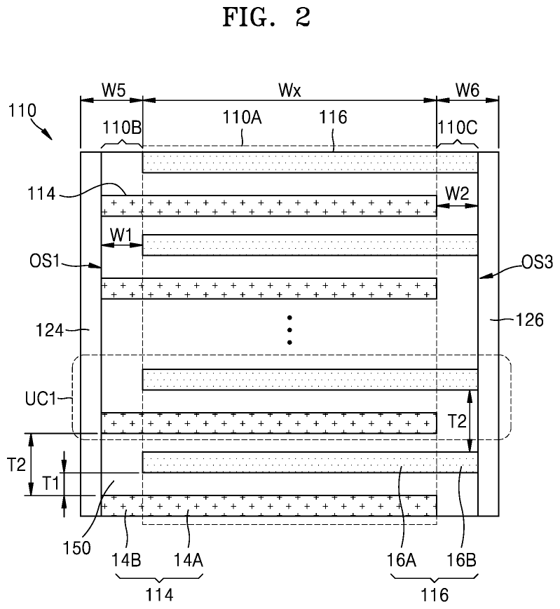

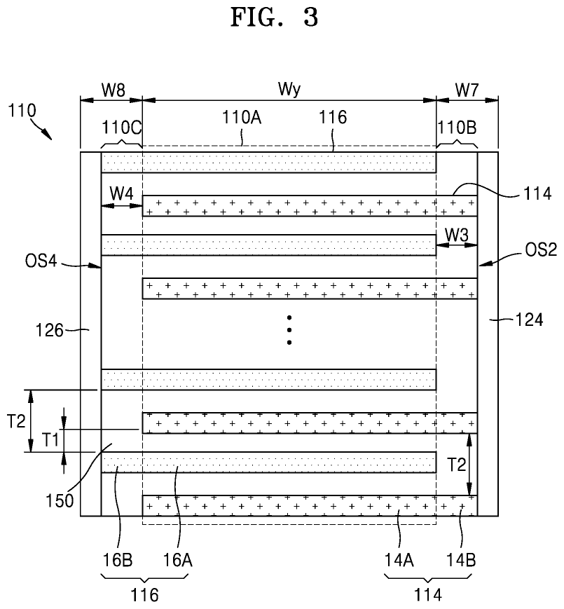

FIG. 1 is a plan view of a first multi-layer ceramic battery 110 including an all-solid electrolyte according to an embodiment. FIG. 2 is a cross-sectional view of the first multi-layer ceramic battery 110 of FIG. 1 taken along line 2-2′ of FIG. 1. FIG. 3 is a cross-sectional view of the first multi-layer ceramic battery 110 of FIG. 1 taken along line 3-3′ of FIG. 1.

Referring to FIGS. 1 to 3, the first multi-layer ceramic battery 110 includes a plurality of unit batteries UC1, which are vertically sequentially stacked. Each of the unit batteries UC1 include a first electrode layer 114, an all-solid electrolyte layer 150, and a second electrode layer 116, which are sequentially stacked. In an embodiment, the first and the second electrode layers 114 and 116 may include a material layer having conductivity sufficient to serve as a current collector. Therefore, the first and the second electrode layers 114 and 116 may be electrode layers and also used as inner current collector layers.

The first multi-layer ceramic battery 110 includes a main region 110A, first and second outer current collector layers 124 and 126, and first and the second peripheral regions 1106 and 110C. The main region 110A is a region in which charging and discharging occur, and is spaced apart from the first and the second outer current collector layers 124 and 126 when viewed in a plan view. Main region herein does not necessarily mean larger region. In an aspect, the main region is an active region. The main region can be bordered by a peripheral region and can be smaller or larger than the peripheral region. When viewed in a plan view, the main region 110A and the first and the second outer current collector layers 124 and 126 are connected by the first and the second peripheral regions 1106 and 110C. The main region 110A and the first outer current collector layer 124 are connected by the first peripheral region 1106. The main region 110A and the second outer current collector layer 126 are connected by the second peripheral region 110C. As shown in FIG. 1, the planar shape of the main region 110A may be a tetragon, and in an embodiment, may be a square, or a rectangle.

Referring to FIG. 1, the first peripheral region 1106 includes a part of the first electrode layer 114 and is arranged around two adjacent surfaces among four surfaces of the main region 110A. The first peripheral region 1106 and the second peripheral region 110C are arranged to face each other in a diagonal direction of the main region 110A. The second peripheral region 110C includes a part of the second electrode layer 116 and is arranged around the remaining two adjacent surfaces of the main region 110A. A first width W1 of the first peripheral region 1106 in a first direction (e.g., the X-axis direction) may be the same as or different from a second width W2 of the second peripheral region 110C in the first direction. A third width W3 of the first peripheral region 1106 in a second direction (e.g., the Y-axis direction) perpendicular to the first direction may be the same as or different from a fourth width W4 of the second peripheral region 110C in the second direction. In an embodiment, the first width W1 and the third width W3 of the first peripheral region 1106 may be the same as or different from each other. In an embodiment, the second width W2 and the fourth width W4 of the second peripheral region 110C may be the same as or different from each other. In an embodiment, the first to fourth widths W1, W2, W3, and W4, respectively, may be the same or substantially the same, and each may be about 2 percent (%) or less, about 1.5% or less, or about 1% or less, or about 0.1% to about 2% of a width Wx of the main region 110A in the first direction, but is not limited thereto. In an embodiment, each of the first to fourth widths W1, W2, W3, and W4 may be about 100 micrometers μm or less, about 75 μm or less, or about 50 μm or less, but is not limited thereto. In an embodiment, a total area of the first and the second peripheral regions 1108 and 110C viewed from a plan view may be less than an area of the main region 110A. For example, the total area of the first and the second peripheral regions 1108 and 110C may be about 10% or less, about 7.5% or less, or about 5% or less, or about 0.1% to about 10%, of the area of the main region 110A, but is not limited thereto. A width Wy of the main region 110A in the second direction may be the same as or different from the width Wx in the first direction.

A first side surface OS1 of the first peripheral region 1108 parallel to a left boundary of the main region 110A and a second side surface OS2 of the first peripheral region 1108 parallel to a lower boundary of the main region 110A and perpendicular to the first side surface OS1 of the first peripheral region 1108 may be covered with the first outer current collector layer 124 and may be in direct contact with the first outer current collector layer 124. The first side surface OS1 may be parallel to or substantially parallel to a plane (Y-Z plane) formed of the Y-axis and the Z-axis. The second side surface OS2 may be parallel to or substantially parallel to a plane (X-Z plane) formed of the X-axis and the Z-axis. In an embodiment, the first outer current collector layer 124 may be a single continuous current collector layer covering the entire first and second side surfaces OS1 and OS2 of the first peripheral region 1108. In an embodiment, the first outer current collector layer 124 may be provided to be divided into a first part covering the first side surface OS1 of the first peripheral region 1108 and a second part covering the second side surface OS2 of the first peripheral region 1108, instead of providing the single continuous current collector layer. Since the first and second side surfaces OS1 and OS2 are perpendicular to each other, when the first outer current collector layer 124 is provided to continuously cover the first and second side surfaces OS1 and OS2, the first outer current collector layer 124 may have a bent part. Accordingly, the entire first outer current collector layer 124 may not be flat.

A third side surface OS3 of the second peripheral region 110C parallel to a right boundary of the main region 110A and a fourth side surface OS4 of the second peripheral region 110C parallel to an upper boundary of the main region 110A and perpendicular to the third side surface OS3 of the second peripheral region 110C may be covered with the second outer current collector layer 126, and may be in direct contact with the second current collector layer 126. The third side surface OS3 may be parallel to or substantially parallel to the first side surface OS1. The fourth side surface OS4 may be parallel to or substantially parallel to the second side surface OS2. In an embodiment, the second outer current collector layer 126 may be a single continuous current collector layer covering the entire third and fourth side surfaces OS3 and OS4 of the second peripheral region 110C. In an embodiment, the second outer current collector layer 126 may be provided to be divided into a first part covering the third side surface OS3 and a second part covering the fourth side surface OS4, instead of providing the single continuous current collector layer. Since the third and fourth side surfaces OS3 and OS4 are perpendicular to each other, the second outer current collector layer 126 continuously covering the third and fourth side surfaces OS3 and OS4 has a bent part like the first outer current collector layer 124, so that the second outer current collector layer 126 is not flat as a whole. In an embodiment, the first and the second outer current collector layers 124 and 126 may have a same thickness, but may have different thicknesses. A fifth width W5 of a region including the first peripheral region 1106 and the first outer current collector layer 124 in the first direction may be the same as or different from a sixth width W6 of a region including the second peripheral region 110C and the second outer current collector layer 126. The fifth and sixth widths W5 and W6 may be substantially the same, and under this condition, widths of the first and the second peripheral regions 1106 and 110C and the thicknesses of the first and the second outer current collector layers 124 and 126 may have various combinations. In an embodiment, under the condition, widths W1 and W2 of the first and the second peripheral regions 1106 and 110C may be the same or different from each other, and the first and the second outer current collector layers 124 and 126 may have the same or different thickness. In an embodiment, under the condition, widths W1 and W2 of the first and the second peripheral regions 1106 and 110C may be substantially the same, and the thicknesses of the first and second outer current collector layers 124 and 126 may be different from each other, and vice versa. Even under the condition in which the fifth and the sixth widths W5 and W6 are different from each other, the first and the second peripheral regions 110B and 110C and the first and the second outer current collector layers 124 and 126 may have various combinations of widths and thicknesses.

A seventh width W7 of a region including the first peripheral region 110B and the first outer current collector layer 124 in the second direction may be the same as or different from an eighth width W8 of a region including the second peripheral region 110C and the second outer current collector layer 126. As in the case of the fifth and the sixth widths W5 and W6, the seventh and the eighth widths W7 and W8 may be substantially the same as or different from each other. The widths of the first and the second peripheral regions 110B and 110C in the second direction and the thicknesses of the first and the second outer current collector layers 124 and 126 may have various combinations satisfying the seventh and the eighth widths W7 and W8.

In an embodiment, each of the fifth to eighth widths W5, W6, W7, and W8 may be about 2% or less, about 1.5% or less, or about 1% or less, or about 0.1% to about 2%, of the width Wx of the main region 110A measured in the first direction or the width Wy of the main region 110A measured in the second direction, but is not limited thereto. In an embodiment, each of the fifth to eighth widths W5, W6, W7, and W8 may be about 200 μm or less, about 150 μm or less, or about 100 μm or less, or about 0.1 μm to about 200 μm, but is not limited thereto.

Referring to FIGS. 2 and 3, the first electrode layer 114 includes a first part 14A belonging to the main region 110A and a second part 14B belonging to the first peripheral region 110B. The second part 14B may be in direct contact with the first outer current collector layer 124. In an embodiment, the second part 14B may contact the first outer current collector layer 124 through another conductive member. In the first direction, the first electrode layer 114 is spaced apart from the second outer current collector layer 126 by the second width W2. In the second direction, the first electrode layer 114 is spaced apart from the second outer current collector layer 126 by the fourth width W4. The division of the first electrode layer 114 into the first and second parts 14A and 14B is merely for convenience of description, and does not imply that the first electrode layer 114 may have been or be physically divided into two parts. This is the same for the second electrode layer 116. The second electrode layer 116 may include a first part 16A belonging to the main region 110A and a second part 16B belonging to the second peripheral region 110C. The entire first part 14A of the first electrode layer 114 and the entire first part 16A of the second electrode layer 116 are vertically alternately stacked and overlapped with each other. The second part 16B of the second electrode layer 116 may be in direct contact with the second outer current collector layer 126. In an embodiment, the second part 16B of the second electrode layer 116 may contact the second outer current collector layer 126 through a conductive member.

The second electrode layer 116 is spaced apart from the first outer current collector layer 124 by the first width W1 in the first direction, and is spaced apart from the first outer current collector layer 124 by the third width W3 in the second direction. Lengths Wx+W1 or Wx+W2 of the first and the second electrode layers 114 and 116 in the first direction may be substantially the same as or different from each other. Lengths Wy+W3 or Wy+W4 of the first and the second electrode layers 114 and 116 in the second direction may be substantially the same as or different from each other. The thicknesses of the first and the second electrode layers 114 and 116 may be substantially the same as each other, but may be different from each other. Each of the first and the second electrode layers 114 and 116 may have a uniform thickness as a whole. The first electrode layer 114 and the second electrode layer 116 alternately stacked vertically may be stacked to have a same or substantially same interval, but may be stacked at different intervals. Since the all-solid electrolyte layer 150 is disposed (e.g., filled) between the first electrode layer 114 and the second electrode layer 116, the interval between the first and the second electrode layers 114 and 116 may be determined according to a thickness of the all-solid electrolyte layer 150. That is, vertically, the interval between the first and the second electrode layers 114 and 116 may be equal to or substantially equal to the thickness of the all-solid electrolyte layer 150.

Referring to FIGS. 2 and 3, the second part 14B of the first electrode layer 114 may be regarded as a part protruding from the main region 110A toward the first outer current collector layer 124. The second part 16B of the second electrode layer 116 may be viewed as a part protruding from the main region 110A toward the second outer current collector layer 126.

In another aspect, the second part 14B of the first electrode layer 114 may be regarded as a part (member) connecting the first part 14A of the first electrode layer 114 with the first outer current collector layer 124. The second part 16B of the second electrode layer 116 may be viewed as a part (member) connecting the first part 16A of the second electrode layer 116 with the second outer current collector layer 126. Accordingly, the second parts 14B and 16B of the first and second electrode layers 114 and 116 may be expressed as protrusions or connection members.

The first peripheral region 110B includes an all-solid electrolyte layer 150 disposed (e.g., provided) between the second part 14Bs of the first electrode layers 114, which are vertically stacked. The first peripheral region 110B does not include the second electrode layer 116. In the first peripheral region 110B, the second part 14B of the first electrode layer 114 and the all-solid electrolyte layer 150 are vertically alternately stacked. The interval between the second parts 14B of the first electrode layer 114 in the first peripheral region 110B, that is, a thickness T2 of the all-solid electrolyte layer 150 provided between the second parts 14B may be thicker than a thickness T1 of the all-solid electrolyte layer 150 provided between the first and second electrode layers 114 and 116 of the main region 110A. The first peripheral region 110B may be seen as a first stack in which the second part 14B of the first electrode layer 114 and the all-solid electrolyte layer 150 are repeatedly and alternately stacked. The first side surface OS1 and the second side surface OS2 become side surfaces of the first stack. The first and the second side surfaces OS1 and OS2 include a side surface of the second part 14B of the first electrode layer 114 and a side surface of the all-solid electrolyte layer 150. At least a part of a side surface of the first stack may be covered with the first outer current collector layer 124 and may be in direct contact with the first outer current collector layer 124. In an embodiment, an entire side surface of the first stack may be covered with the first outer current collector layer 124 and may be in direct contact with the first outer current collector layer 124.

The second peripheral region 110C includes an all-solid electrolyte layer 150 provided between the second parts 16B of the second electrode layers 116, which are vertically stacked.

The second peripheral region 110C does not include the first electrode layer 116. In the second peripheral region 110C, the second part 16B of the second electrode layer 116 and the all-solid electrolyte layer 150 are vertically alternately stacked.

The interval between the second parts 16B of the second electrode layer 116 in the second peripheral region 110C, that is, the thickness T2 of the all-solid electrolyte layer 150 provided between the second parts 16B may be thicker than the thickness T1 of the all-solid electrolyte layer 150 provided between the first and the second electrode layers 114 and 116 of the main region 110A. The second peripheral region 110C may be seen as a second stack in which the second part 16B of the second electrode layer 116 and the all-solid electrolyte layer 150 are repeatedly stacked. The third side surface OS3 and the fourth side surface OS4 become side surfaces perpendicular to each other of the second stack.

The third and the fourth side surfaces OS3 and OS4 include a side surface of the second part 16B of the second electrode layer 116 and the side surface of the all-solid electrolyte layer 150. At least a part of a side surface of the second stack may be covered with the second outer current collector layer 126 and may be in direct contact with the second outer current collector layer 126. In an embodiment, an entire side surface of the second stack may be covered with the second outer current collector layer 126 and may be in direct contact with the second outer current collector layer 126.

The first and the second outer current collector layers 124 and 126 may be arranged to face each other in two different directions. In an embodiment, the first and the second outer current collector layers 124 and 126 may include parts facing each other around the main region 110A in the first direction. In an embodiment, the first and the second outer current collector layers 124 and 126 may include parts facing each other around the main region 110A in the second direction.

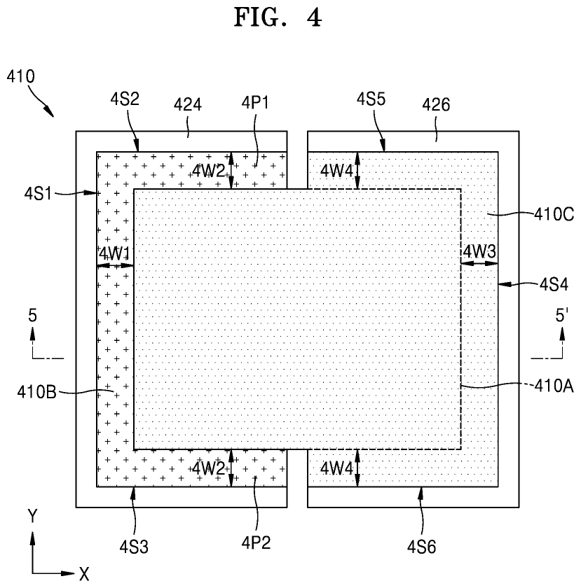

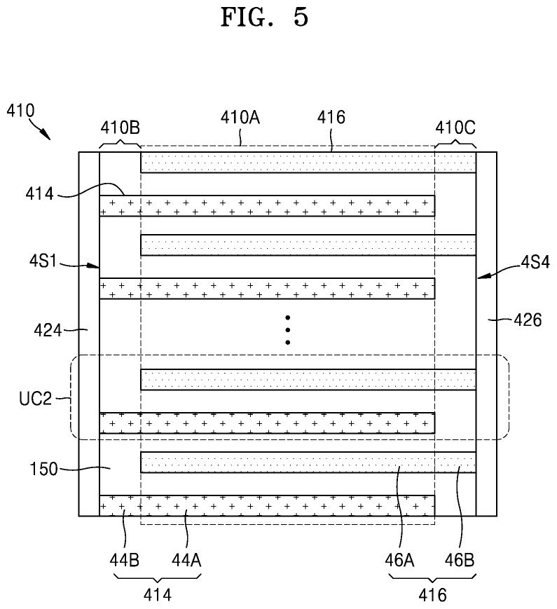

FIG. 4 is a plan view of a second multi-layer ceramic battery 410 according to an embodiment. FIG. 5 is a cross-sectional view taken along line 5-5′ of FIG. 4.

Referring to FIGS. 4 and 5, the second multi-layer ceramic battery 410 includes a main region 410A in which charging and discharging occur, and first and second peripheral regions 410B and 410C arranged around the main region 410A. A planar shape of the main region 410A is rectangular, but may have geometrically different shapes. The first and the second peripheral regions 410B and 410C may be provided to be symmetrical with respect to the main region 410A. In an embodiment, the first and the second peripheral regions 4108 and 410C may be bilaterally symmetrical with respect to the main region 410A. The first and the second peripheral regions 410B and 410C are spaced apart from each other. The first peripheral region 410B may be disposed (e.g., positioned) at a left side of the main region 410A, may cover an entire left boundary of the main region 410A, and may be provided to cover a part of an upper boundary and a part of a lower boundary of the main region 410A. A length of a part 4P1 covering the upper boundary of the main region 410A of the first peripheral region 4108 and a length of a part 4P2 covering the lower boundary thereof may be the same or substantially the same as each other, or may be different from each other. A range of a width 4W1 of the first peripheral region 410B in a first direction (e.g., an X-axis direction) and a range of a width 4W2 of the first peripheral region 410B in a second direction (e.g., a Y-axis direction) may be the same as those of the first peripheral region 1108 in the first multi-layer ceramic battery 110, but actual width values in the same width range may be different from each other in the first and the second multi-layer ceramic batteries 110 and 410. In an embodiment, the width 4W1 of the first peripheral region 410B in the first direction and the width 4W2 of the first peripheral region 4108 in the second direction may be the same or substantially the same as each other, but may be different from each other.

The second peripheral region 410C may be positioned at a right side of the main region 410A, may cover an entire right boundary of the main region 410A, and may be provided to cover a part of the upper boundary and a part of the lower boundary of the main region 410A. A length of a part 4P3 covering the upper boundary of the main region 410A of the second peripheral region 410C and a length of a part 4P4 covering the lower boundary thereof may be the same or substantially the same as each other, or may be different from each other. A range of a width 4W3 of the second peripheral region 410C in the first direction and a range of a width 4W4 of the second peripheral region 410C in the second direction may be the same as those of the second peripheral region 110C in the first multi-layer ceramic battery 110, but actual width values in the same width range may be different from each other in the first and the second multi-layer ceramic batteries 110 and 410. In an embodiment, the width 4W3 of the second peripheral region 410C in the first direction and the width 4W4 of the second peripheral region 410C in the second direction may be the same or substantially the same as each other, but may be different from each other. The widths 4W1 and 4W2 of the first peripheral region 4108 may be the same as or substantially the same as the widths 4W3 and 4W4 of the second peripheral regions 410C, but may be different from each other. A relationship between a width of the main region 410A and widths of the first and the second peripheral regions 410B and 410C in the first or the second direction may be the same as or substantially the same as a relationship between a width of the main region 110A of the first multi-layer ceramic battery 110 and widths of the peripheral regions 1108 and 110C, but may be different from each other. In addition, a relationship between an area of the main region 410A and areas of the first and the second peripheral regions 4108 and 410C may be the same as or substantially the same as a relationship between an area of the main region 110A of the first multi-layer ceramic battery 110 and areas of the peripheral regions 1108 and 110C, but may be different from each other.

A perimeter of the first peripheral region 4108 may be covered with the first outer current collector layer 424 and may be in direct contact with the first outer current collector layer 424. In an embodiment, a left side (first side) 4S1, an upper side (second side) 4S2, and a lower side (third side) 4S3 of the first peripheral region 4108 may be covered with the first outer current collector layer 424, and may be in direct contact with the first outer current collector layer 424. In an embodiment, the entire first to third side surfaces 4S1 to 4S3 of the first peripheral region 4108 may be in direct contact with the first outer current collector layer 424. In an embodiment, since the first outer current collector layer 424 continuously covers the first to third side surfaces 4S1 to 4S3 perpendicular to each other, the first outer current collector layer 424 is not flat as a whole and may include two bent parts. In an embodiment, instead of disposing (e.g., forming) the first outer current collector layer 424 as a single layer continuously covering the first to third side surfaces 4S1 to 4S3, a first part of the first outer current collector layer 424 may be formed on the first side surface 4S1, a second part of the first outer current collector layer 424 may be formed on the second side surface 4S2, and a third part of the first outer current collector layer 424 may be formed on the third side surface 4S3. In this case, the first to third parts are spaced apart from each other. In other words, the first outer current collector layer 424 may be provided on each of the first to third side surfaces 4S1 to 4S3. In this case, the first outer current collector layers 424 provided on the first to third side surfaces 4S1 to 4S3 may be spaced apart from each other.

A perimeter of the second peripheral region 410C may be covered with the second outer current collector layer 426 and may be in direct contact with the second outer current collector layer 426. In an embodiment, a right side (fourth side) 4S4, an upper side (fifth side) 4S5, and a lower side 4S6 (sixth side) of the second peripheral region 410C may be covered with the second outer current collector layer 426, and may be in direct contact with the second outer current collector layer 426. In an embodiment, the entire fourth to sixth side surfaces 4S4 to 4S6 of the second peripheral region 410C may be in direct contact with the second outer current collector layer 426.

In an embodiment, since the second outer current collector layer 426 continuously covers the fourth to sixth side surfaces 4S4 to 4S6 perpendicular to each other, the second outer current collector layer 426 is not flat as a whole and includes two bent parts. In an embodiment, instead of forming the second outer current collector layer 426 as a single layer continuously covering the fourth to sixth side surfaces 4S4 to 4S6, a first part of the second outer current collector layer 426 may be formed on the fourth side surface 4S4, a second part of the second outer current collector layer 426 may be formed on the fifth side surface 4S5, and a third part of the second outer current collector layer 426 may be formed on the sixth side surface 4S6. In this case, the first to third parts may be spaced apart from each other. In other words, the second outer current collector layer 426 may be provided on each of the fourth to sixth side surfaces 4S4 to 4S6. In this case, the second outer current collector layers 426 provided on the fourth to sixth side surfaces 4S4 to 4S6 may be spaced apart from each other.

A relationship between thicknesses of the first and the second outer current collector layers 424 and 426 may be the same as a relationship between thicknesses of the first and second outer current collector layers 124 and 126 of the first multi-layer ceramic battery 110. In addition, a relationship between a width of a combined region of the outer current collector layers 424 and 426 and the peripheral regions 4106 and 410C and a width of the main region 410A may be the same as a relationship between a width of a combined region of the outer current collector layers 124 and 126 and the peripheral regions 1106 and 110C of the first multi-layer ceramic battery 110 and a width of the main region 110A thereof.

Referring to FIG. 5, the second multi-layer ceramic 410 includes a plurality of unit batteries UC2 that are vertically and sequentially stacked. Each of the unit batteries UC2 include a first electrode layer 414, an all-solid electrolyte layer 150, and a second electrode layer 416, which are sequentially stacked. The first and the second electrode layers 414 and 416 may be provided parallel to or substantially parallel to each other. Thicknesses of the first and the second electrode layers 414 and 416 may be the same or substantially the same as each other, but may be different from each other. In a layer structure in which a plurality of unit batteries UC2 of the second multi-layer ceramic battery 410 are vertically and sequentially stacked, the remaining parts of the first and the second electrode layers 414 and 416 except for side surfaces may be buried in the all-solid electrolyte layer 150. The layer structure of the second multi-layer ceramic battery 410 may be expressed as a layer structure in which the first and the second electrode layers 414 and 416 are alternately stacked two or more times vertically in the all-solid electrolyte layer 150.

Materials of the first and the second electrode layers 414 and 416 may be the same as or be different from those of the first and the second electrode layers 114 and 116 of the first multi-layer ceramic battery 110. In an embodiment, each of the first and the second electrode layers 414 and 416 may be a single layer, but each layer may not be a single layer. In an embodiment, similar to the first and the second electrode layers 114 and 116 of the first multi-layer ceramic battery 110, a conductivity of the first electrode layer 414 and a conductivity of the second electrode layer 416 may be substantially the same. Here, “substantially the same” may include both a case where the conductivities of the first and the second electrode layers 414 and 416 are the same, a case where the conductivities of the first and the second electrode layers 414 and 416 are the same in a range of allowable errors, and a case where a difference in the conductivities of the first and the second electrode layers 414 and 416 do not exceed a set range. Shapes of the first and the second outer current collectors 424 and 426 may vary depending on the difference in the conductivities of the first and the second electrode layers 414 and 416, which will be described in another example.

The first electrode layer 414 may be a cathode layer or an anode layer, and may include a first part 44A belonging to the main region 410A and a second part 44B belonging to the first peripheral region 410B. Since the first electrode layer 414 is a continuous single material layer, there is no physical boundary between the first and the second parts 44A and 44B. “The first part” and “the second part” are expressions used only for convenience to distinguish between a region belonging to the main region 410A and a region belonging to the first peripheral region 410B in the first electrode layer 414. This is equally applied to the description of the second electrode layer 416. The second electrode layer 416 may be a cathode layer or an anode layer, and may include a first part 46A belonging to the main region 410A and a second part 46B belonging to the first peripheral region 410C. A layer configuration of the main region 410A and the first and the second peripheral regions 410B and 410C may be the same as a layer configuration of the main region 110A and the first and the second peripheral regions 110B and 110C of the first multi-layer ceramic battery 110. In an embodiment, the first parts 44A and 46A of the first and second electrode layers 414 and 416 may vertically overlap in the main region 410A. The first peripheral region 410B includes a second part 44B of the first electrode layer 414 and an all-solid electrolyte layer 150, and does not include the second electrode layer 416. In the first peripheral region 410B, the second part 44B of the first electrode layer 414 and the all-solid electrolyte layer 150 are alternately stacked two or more times vertically. The first side surface 4S1 of the first peripheral region 410B includes a side surface of the first electrode layer 414, that is, a side surface of the second part 44B and a side surface of the all-solid electrolyte layer 150. The first outer current collector layer 424 may be in direct contact with a side surface of the first electrode layer 414 and a side surface of the all-solid electrolyte layer 150, and is spaced apart from the second electrode layer 416.

The second peripheral region 410C includes a second part 46B of the second electrode layer 416 and an all-solid electrolyte layer 150, and does not include the first electrode layer 414. In the second peripheral region 410C, the second part 46B of the second electrode layer 416 and the all-solid electrolyte layer 150 are alternately stacked two or more times vertically. The fourth side surface 4S4 of the second peripheral region 410C may include a side surface of the second electrode layer 416, that is, a side surface of the second part 46B and a side surface of the all-solid electrolyte layer 150. The second outer current collector layer 426 may be in direct contact with the side surface of the second electrode layer 416 and the side surface of the all-solid electrolyte layer 150, and is spaced apart from the first electrode layer 414.

Referring to FIG. 4, it may be seen that the second and the third side surfaces 4S2 and 4S3 of the first peripheral region 410B also include a side surface of the first electrode layer 414 and a side surface of the all-solid electrolyte layer 150. In addition, it may be seen that the fifth and the sixth side surfaces 4S5 and 4S6 of the second peripheral region 410C also include the side surface of the second electrode layer 416 and the side surface of the all-solid electrolyte layer 150.

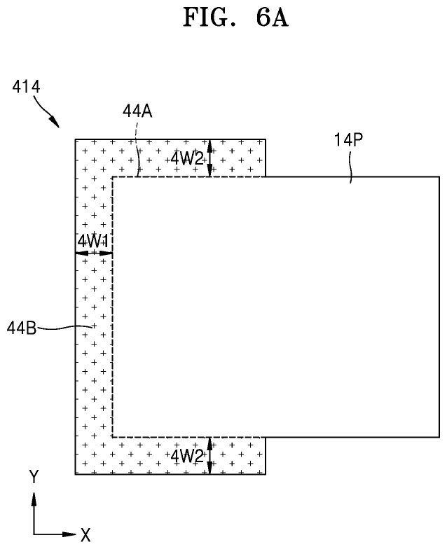

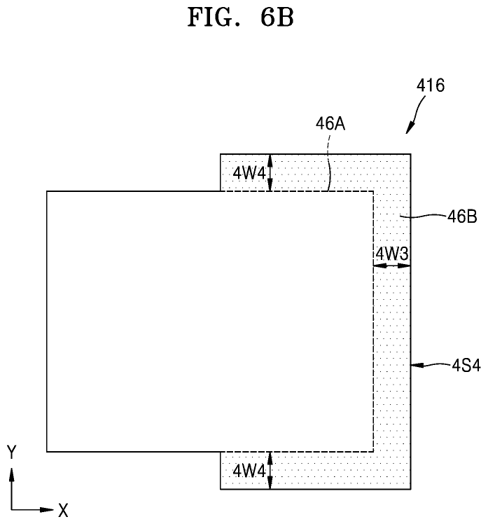

FIGS. 6A and 6B are plan views respectively illustrating examples of the first electrode layer 414 and the second electrode layer 416 of the second multi-layer ceramic battery 410. FIG. 6A illustrates the first electrode layer 414, and FIG. 6B illustrates the second electrode layer 416.

Referring to FIGS. 6A and 6B together, the first electrode layer 414 and the second electrode layer 416 may have a structure which is bilaterally symmetrical to each other. The second part 44B of the first electrode layer 414 partially surrounds the perimeter of the first part 44A. The second part 44B completely surrounds a left boundary of the first part 44A and also surrounds some of upper and lower boundaries of the first part 44A. A portion of the first part 44A protrudes to the right from the right boundary of the second part 44B. A width of the protruding part 14P of the first part 44A in the Y-axis direction is less than a width of the second part 44B. Accordingly, a step may be formed between the second part 44B and the protruding part 14P of the first part 44A. Since the first electrode layer 414 has a vertically symmetrical structure, the step may also exist symmetrically above and below the first electrode layer 414. In an aspect, the second part 44B may be viewed as a shape in which the first part 44A protrudes by given lengths (widths) 4W1 and 4W2 in three different directions, that is, a left direction and up and down directions.

Except that the second electrode layer 416 has a bilaterally symmetrical structure with the first electrode layer 414, all relationships between the first part 46A and the second part 46B of the second electrode layer 416 may be the same as those between the first part 44A and the second part 44B of the first electrode layer 414. In other words, a size and a shape of the second electrode layer 416 may be the same as a size and a shape of the first electrode layer 414 except that the second electrode layer 416 has a bilaterally symmetrical structure with the first electrode layer 414.

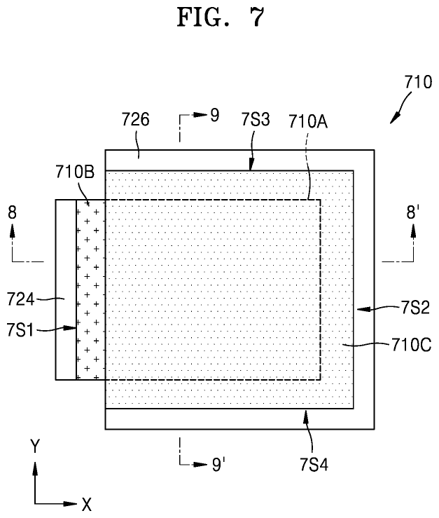

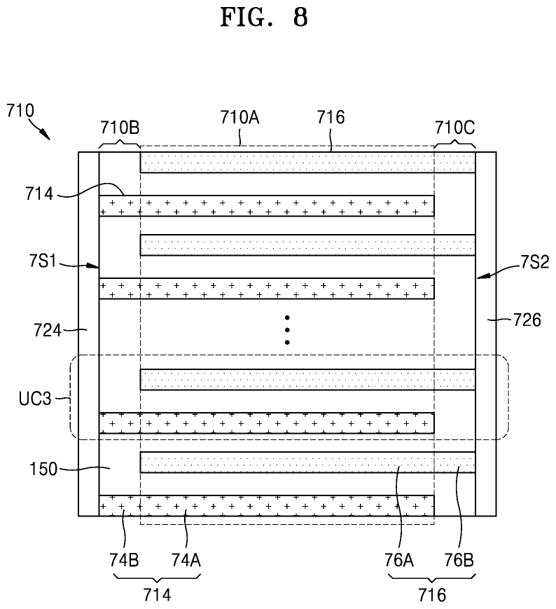

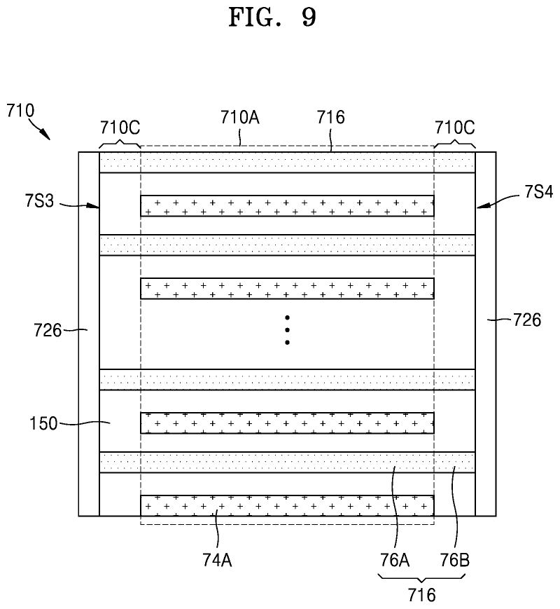

FIG. 7 is a plan view of a third multi-layer ceramic battery 710 according to an embodiment. FIG. 8 is a cross-sectional view taken along line 8-8′ of FIG. 7, and FIG. 9 is a cross-sectional view taken along line 9-9′ of FIG. 7.

Referring to FIG. 7, the third multi-layer ceramic battery 710 includes a main region 710A in which charging and discharging occur, first and second peripheral regions 710B and 710C arranged around the main region 710A to surround the main region 710A, and first and second outer current collector layers 724 and 726 provided on side surfaces of the first and second peripheral regions 710B and 710C. The main region 710A may have a rectangular shape, but may have a geometrically different shape.

The first peripheral region 710B may be provided from a left side of the main region 710A to surround an entire left boundary of the main region 710A. The first peripheral region 710B may cover the entire left boundary of the main region 710A. The first outer current collector layer 724 is provided on a first side surface 7S1 of the first peripheral region 710B. The first side surface 7S1 may be spaced apart from the left boundary of the main region 710A, may be parallel to the left boundary, and may be parallel to or substantially parallel to the Y-Z plane. The first outer current collector layer 724 may be in direct contact with the first side surface 7S1, may cover a entire first side surface 7S1, but may be provided to cover only a part of the first side surface 7S1. As a result, the first outer current collector layer 724 and the main region 710A may be arranged to face each other with the first peripheral region 710B placed therebetween. In other words, the first peripheral region 710B may be positioned between the first outer current collector layer 724 and the main region 710A, and the first peripheral region 7106 may serve to connect the first outer current collector layer 724 and the main region 710A.

The second peripheral region 710C may be provided to surround the main region 710A on a right side of and above and below the main region 710A. The second peripheral region 710C may cover all of a right boundary, an upper boundary, and a lower boundary of the main region 710A. The second outer current collector layer 724 is provided on a second side surface 7S2, a third side surface 7S3, and a fourth side surface 7S4 of the second peripheral region 710C. The second to fourth side surfaces 7S2 to 7S4 are spaced apart from the main region 710A. The second side surface 7S2 may be parallel to or substantially parallel to the first side surface 7S1 of the first peripheral region 7106. The third and the fourth side surfaces 7S3 and 7S4 may be parallel to or substantially parallel to each other, and may be perpendicular to or substantially perpendicular to the second side surface 7S2. The third and the fourth side surfaces 7S3 and 7S4 may be parallel to or substantially parallel to the X-Z plane.

The second outer current collector layer 726 may come into direct contact with the second to fourth side surfaces 7S2 to 7S4 and may be provided to continuously cover an entire second to fourth side surfaces 7S2 to 7S4. In an embodiment, the second outer current collector layer 726 may be provided only on some (e.g., at least one) of the second to fourth side surfaces 7S2 to 7S4, or on at least two side surfaces thereof. In an embodiment, when the second outer current collector layer 726 is provided on the second to fourth side surfaces 7S2 to 7S4, the second outer current collector layer 726 may be formed only on a partial region of each of the side surfaces 7S2 to 7S4, and in this case, the second outer current collector layer 726 formed on each of the side surfaces 7S2 to 7S4 may be spaced apart from each other. The second outer current collector layer 726 is spaced apart from the main region 710A. The second peripheral region 710C may be a region connecting the second outer current collector layer 726 and the main region 710A between the second outer current collector layer 726 and the main region 710A.

An area in which the second outer current collector layer 726 is in contact with the second peripheral region 710C may be larger than an area in which the first outer current collector layer 724 is in contact with the first peripheral region 710B. This is because a conductivity of the electrode layer included in the first peripheral region 710B is greater than that of the electrode layer included in the second peripheral region 710C.

In an embodiment, features and limitations associated with thicknesses of the first and second outer current collector layers 724 and 726 and widths of the first and second peripheral regions 710B and 710C may be similar to features and limitations associated with thicknesses of the first and second outer current collector layers 124 and 126 of the first multi-layer ceramic battery 110 and widths of the first and second peripheral regions 1106 and 110C.

Referring to FIGS. 8 and 9 together, a layer configuration or a layer structure shown in a cross section (FIG. 8) cut in a line 8-8′ direction of the third multi-layer ceramic battery 710 may be the same as a layer configuration or a layer structure of the second multi-layer ceramic battery 410 shown in FIG. 5, except for only different reference numbers.

In the third stacked battery 710, a unit battery UC3 includes a first electrode layer 714, an all-solid electrolyte layer 150, and a second electrode layer 716, which are sequentially stacked. The third multi-layer ceramic battery 710 includes a plurality of unit batteries UC3, which are vertically stacked. One of the first and the second electrode layers 714 and 716 is a cathode layer, and the other is an anode layer. In an embodiment, thicknesses of the first and the second electrode layers 714 and 716 may be the same or substantially the same as each other, but may be different from each other. In an embodiment, lengths of the first and the second electrode layers 714 and 716 in the horizontal direction or the first direction (e.g., the X-axis direction) may be the same or substantially the same as each other, but may be different from each other. When the first and the second electrode layers 714 and 716 have different lengths in the first direction, widths of the first and the second peripheral regions 710B and 710C may be different from each other in the first direction. Since sizes of the first and the second peripheral regions 710B and 710C may affect the energy density of the battery, the setting or design of the first and the second peripheral regions 710B and 710C may be performed in a direction in which the reduction in energy density of the battery is minimized. In an embodiment, the first and the second peripheral regions 710B and 710C may be set or designed such that a decrease in battery energy density as the first and the second peripheral regions 710B and 710C are provided is about 5% or less, about 4% or less, or about 3% or less, or about 0.1% to about 5%.

The first electrode layer 714 may include a first part 74A belonging to the main region 710A and a second part 74B belonging to the first peripheral region 710B. The second electrode layer 716 may include a first part 76A belonging to the main region 710A and a second part 76B belonging to the second peripheral region 710C. The all-solid electrolyte layer 150 may be included in all of the main region 710A and the first and the second peripheral regions 710B and 710C. In the main region 710A, the first parts 74A and 76A of the first and the second electrode layers 714 and 716 are alternately stacked vertically twice or more, and the space between the first parts 74A and 76A is filled with an all-solid electrolyte layer 150.

The first peripheral region 710B is a region in which the second part 74B of the first electrode layer 714 and the all-solid electrolyte layer 150 are alternately stacked two or more times in the vertical direction. The second electrode layer 716 is not included in the first peripheral region 710B. Accordingly, the first side surface 7S1 of the first peripheral region 710B includes a side surface of the first electrode layer 714, that is, a side surface of the second part 74B and a side surface of the all-solid electrolyte layer 150. The first outer current collector layer 724 may cover an entire side surface of the first electrode layer 714 and the side surface of the all-solid electrolyte layer 150 of the first peripheral region 710B, and may be in direct contact with both side surfaces.

The second peripheral region 710C is a region in which the second part 76B of the second electrode layer 716 and the all-solid electrolyte layer 150 are alternately stacked two or more times in the vertical direction. The second peripheral region 710C does not include the first electrode layer 714. Accordingly, the second to fourth side surfaces 7S2 to 7S4 of the second peripheral region 710C include a side surface of the second electrode layer 716, that is, a side surface of the second part 76B and a side surface of the all-solid electrolyte layer 150. The second outer current collector layer 726 may cover an entire side surface of the second electrode layer 716 of the second peripheral region 710C and an entire side surface of the all-solid electrolyte layer 150 in the second to fourth side surfaces 7S2 to 7S4, and may be in direct contact with both side surfaces.

The first peripheral region 710B includes the first electrode layer 714 having relatively high conductivity, and does not include the second electrode layer 716 having less conductivity than the first electrode layer 714.

Meanwhile, the second peripheral region 710C includes the second electrode layer 716 and does not include the first electrode layer 714. Accordingly, a conductivity of the first peripheral region 710B may be greater than that of the second peripheral region 710C. Therefore, as illustrated in FIG. 7, an area in which the second peripheral region 710C contacts the second outer current collector layer 726 may be larger than an area in which the first peripheral region 710B contacts the first outer current collector layer 724.

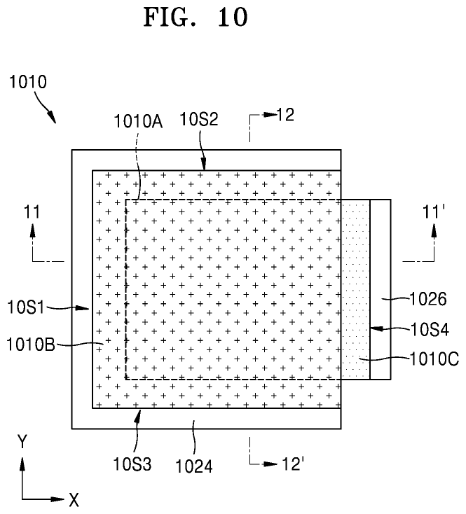

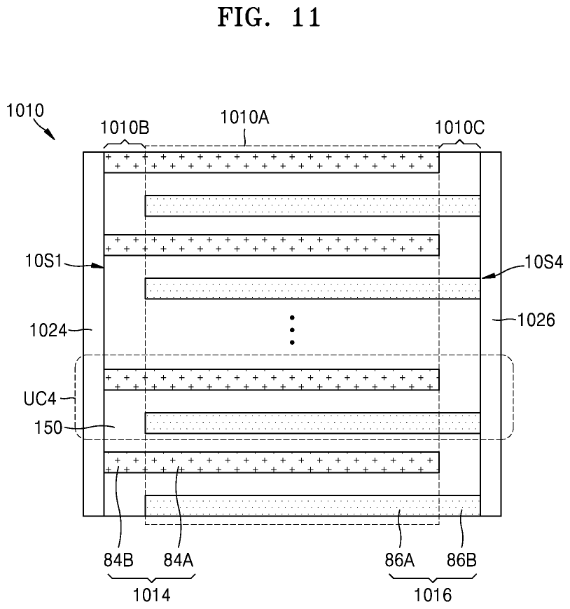

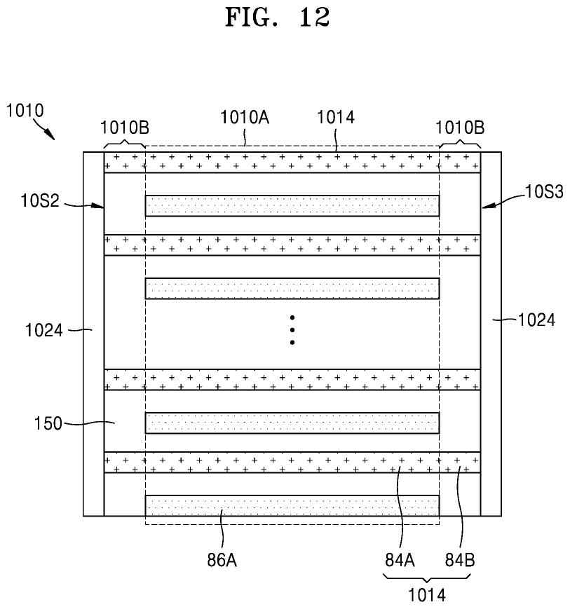

FIG. 10 is a plan view of a fourth multi-layer ceramic battery 1010 according to an embodiment. FIG. 11 is a cross-sectional view taken along line 11-11′ of FIG. 10, and FIG. 12 is a cross-sectional view taken along line 12-12′ of FIG. 10.

The fourth multi-layer ceramic battery 1010 may be opposite to the third multi-layer ceramic battery 710 shown in FIGS. 7 to 9. In the fourth multi-layer ceramic battery 1010, a conductivity of a first peripheral region 1010B may be less than that of a second peripheral region 1010C. In other words, a conductivity of the first electrode layer 1014 may be less than that of the second electrode layer 1016.

Referring to FIG. 10, the fourth multi-layer ceramic battery 1010 includes a main region 1010A in which charging and discharging occur, the first and the second peripheral regions 1010B and 1010C arranged around the main region 1010A and surrounding the main region 1010A, and first and the second outer current collector layers 1024 and 1026 provided on side surfaces of the first and the second peripheral regions 1010B and 1010C.

The main region 1010A may have a rectangular shape, but may have a geometrically different shape.

The first peripheral region 1010B may be provided to surround the main region 1010A on a left side of the main region 1010A and above and below the main region 1010A. The first peripheral region 1010B may cover all of a left boundary, an upper boundary, and a lower boundary of the main region 1010A. A first outer current collector layer 1024 is provided on a first side surface 10S1, a second side surface 10S2, and a third side surface 10S3 of the first peripheral region 1010B. The first outer current collector layer 1024 may be a single layer or a multi-layer, but is not limited thereto. The first to third side surfaces 10S1 to 10S3 are spaced apart from the main region 1010A. The first side surface 10S1 may be parallel to or substantially parallel to the Y-Z plane. The second and the third side surfaces 10S2 and 10S3 may be parallel to or substantially parallel to each other, and may be perpendicular to or substantially perpendicular to the first side surface 10S1. The second and the third side surfaces 10S2 and 10S3 may be parallel to or substantially parallel to the X-Z plane.

The first outer current collector layer 1026 may directly contact the first to third side surfaces 10S1 to 10S3, and may be provided to continuously cover an entire first to third side surfaces 10S1 to 10S3.

In an embodiment, the first outer current collector layer 1024 may be provided only on some (e.g., at least one) of the first to third side surfaces 10S1 to 10S3, or on at least two side surfaces. In an embodiment, when the first outer current collector layer 1024 is provided on the first to third side surfaces 10S1 to 10S3, the first outer current collector layer 1024 may be formed only on a partial region of each of the side surfaces 10S1 to 10S3, and in this case, the first outer current collector layer 1024 formed on each of the side surfaces 10S1 to 10S3 may be spaced apart from each other. The first outer current collector layer 1024 may be spaced apart from the main region 1010A. The first peripheral region 1010B may be a region connecting the first outer current collector layer 1024 and the main region 1010A between the first outer current collector layer 1024 and the main region 1010A.

The second peripheral region 1010C may be provided on a right side of the main region 1010A to surround an entire right boundary of the main region 1010A. The second peripheral region 1010C may cover the entire right boundary of the main region 1010A. The second outer current collector layer 1024 is provided on a fourth side surface 10S4 of the second peripheral region 1010C. The fourth side surface 10S4 may be spaced apart from a right boundary of the main region 1010A, may be parallel to the right boundary, and may be parallel to or substantially parallel to the Y-Z plane. The second outer current collector layer 1026 may directly contact the fourth side surface 10S4, may be provided to cover an entire fourth side surface 10S4, or may be provided to cover only a part of the fourth side surface 10S4. As a result, the second outer current collector layer 1026 and the main region 1010A are arranged to face each other with the second peripheral region 1010C placed therebetween. The second peripheral region 1010C serves to connect the second outer current collector layer 1026 with the main region 1010A.

An area in which the first outer current collector layer 1024 contacts the first peripheral region 1010B may be larger than an area in which the second outer current collector layer 1026 contacts the second peripheral region 1010C. This is because, as mentioned above, the conductivity of the electrode layer included in the first peripheral region 1010B is less than that of the electrode layer included in the second peripheral region 1010C.

In an embodiment, features and limitations associated with thicknesses of the first and second outer current collector layers 1024 and 1026 and widths of the first and second peripheral regions 1010B and 1010C may be similar to the features and limitations associated with thicknesses of the first and second outer current collector layers 124 and 126 of the first multi-layer ceramic battery 110 and widths of the first and second peripheral regions 1106 and 110C.

Referring to FIGS. 11 and 12 together, a layer configuration or layer structure of the fourth multi-layer ceramic battery 1010 may be the same as the layer configuration or layer structure of the third multi-layer ceramic battery 710 of FIGS. 8 and 9, except that the positions of the first electrode layer 1014 and the second electrode layer 1016 are reversed.

In the fourth multi-layer ceramic battery 1010, a unit battery UC4 includes a second electrode layer 1016, an all-solid electrolyte layer 150, and a first electrode layer 1014, which are sequentially stacked. The fourth multi-layer ceramic battery 1010 includes a plurality of vertically stacked unit batteries UC4. One of the first and the second electrode layers 1014 and 1016 is a cathode layer, and the other is an anode layer. In an embodiment, thicknesses of the first and the second electrode layers 1014 and 1016 may be the same or substantially the same as each other, but may be different from each other. In an embodiment, lengths of the first and the second electrode layers 1014 and 1016 in the horizontal direction or the first direction (e.g., the X-axis direction) may be the same or substantially the same as each other, but may be different from each other. When the first and the second electrode layers 1014 and 1016 have different lengths in the first direction, widths of the first and the second peripheral regions 1010B and 1010C may be different from each other in the first direction. Since sizes of the first and the second peripheral regions 1010B and 1010C may affect the energy density of the battery, a setting or a design of the first and the second peripheral regions 1010B and 1010C may be performed in a direction in which the reduction in energy density of the battery is minimized. In an embodiment, when the battery energy density decreases due to the provision of the first and the second peripheral regions 1010B and 1010C, the first and the second peripheral regions 1010B and 1010C may be set or designed such that the energy density decrease is about 5% or less, about 4% or less, or about 3% or less, or about 0.1% to about 5%.

The first electrode layer 1014 may include a first part 84A belonging to the main region 1010A and a second part 84B belonging to the first peripheral region 1010B. The second electrode layer 1016 may include a first part 86A belonging to the main region 1010A and a second part 86B belonging to the second peripheral region 1010C. The all-solid electrolyte layer 150 may be included in all of the main region 1010A and the first and the second peripheral regions 1010B and 1010C. In the main region 1010A, the first parts 84A and 86A of the first and the second electrode layers 1014 and 1016 are alternately stacked vertically twice or more, and the space between the first parts 84A and 86A is filled with an all-solid electrolyte layer 150.

The first peripheral region 1010B is a region in which the second part 84B of the first electrode layer 1014 and the all-solid electrolyte layer 150 are alternately stacked two or more times in the vertical direction. The first peripheral region 1010B does not include the second electrode layer 1016. Accordingly, the first to third side surfaces 10S1 to 10S3 of the first peripheral region 1010B include a side surface of the first electrode layer 1014, that is, a side surface of the second part 84B and a side surface of the all-solid electrolyte layer 150. The first outer current collector layer 1024 may cover an entire side surface of the first electrode layer 1014 of the first peripheral region 1010B and an entire side surface of the all-solid electrolyte layer 150 in the first to third side surfaces 10S1 to 10S3, and may be in direct contact with both side surfaces.

The second peripheral region 1010C is a region in which the second part 86B of the second electrode layer 1016 and the all-solid electrolyte layer 150 are alternately stacked two or more times in the vertical direction. The first electrode layer 1014 is not included in the second peripheral region 1010C. Accordingly, the fourth side surface 10S4 of the second peripheral region 1010C includes a side surface of the second electrode layer 1016, that is, a side surface of the second part 86B and a side surface of the all-solid electrolyte layer 150. The second outer current collector layer 1026 may cover an entire side surface of the second electrode layer 1016 and an entire side surface of the all-solid electrolyte layer 150 of the second peripheral region 1010C, and may be in direct contact with the side surface of the second electrode layer 1016 and the side surface of the all-solid electrolyte layer 150.

The first peripheral region 1010B includes the first electrode layer 1014 having relatively low conductivity, does not include the second electrode layer 1016 having greater conductivity than that of the first electrode layer 1014, while the second peripheral region 1010C includes the second electrode layer 1016, and does not include the first electrode layer 1014. Accordingly, a conductivity of the first peripheral region 1010B may be less than that of the second peripheral region 1010C. Therefore, a contact area between the first peripheral region 1010B and the first outer current collector layer 1024 may be larger than a contact area between the second peripheral region 1010C and the second outer current collector layer 1026, as illustrated in FIG. 10.

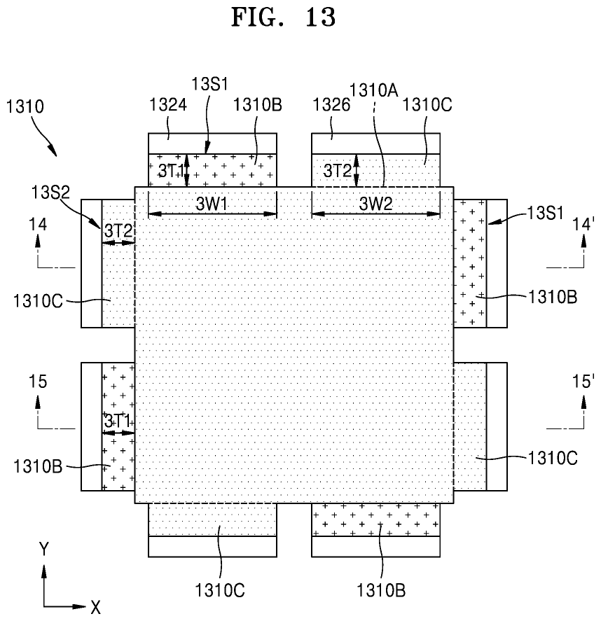

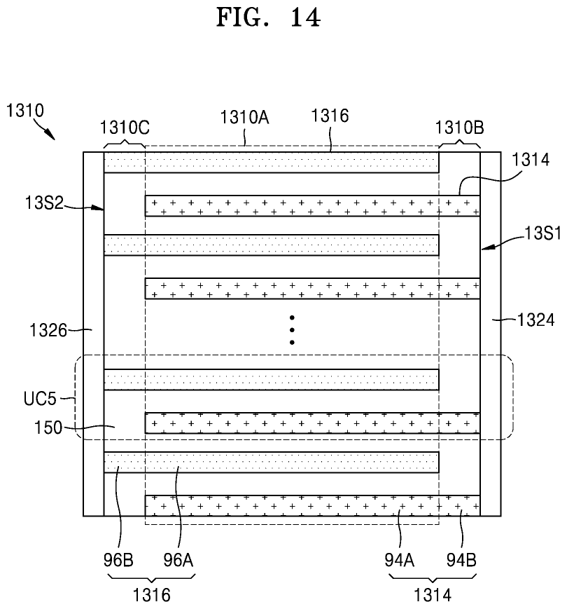

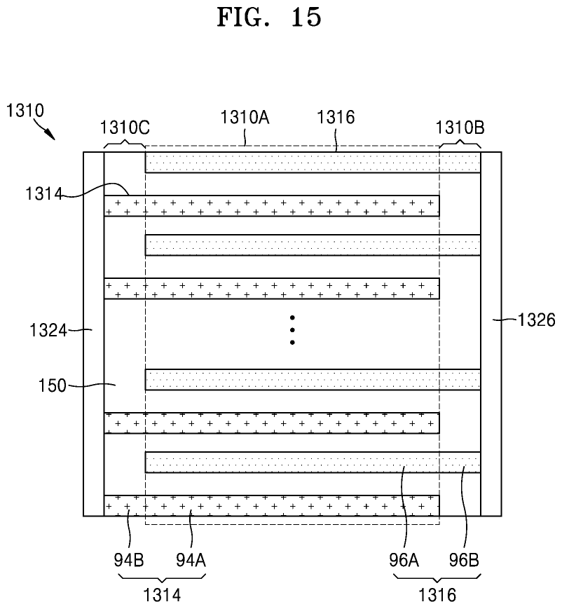

FIG. 13 is a plan view of a fifth multi-layer ceramic battery 1310 according to an embodiment. FIG. 14 is a cross-sectional view taken along line 14-14′ of FIG. 13, and FIG. 15 is a cross-sectional view taken along line 15-15′ of FIG. 13.

Referring to FIG. 13, the fifth multi-layer ceramic battery 1310 includes a main region 1310A in which charging and discharging occur, a plurality of first peripheral regions 1310B and a plurality of second peripheral regions 1310C, which are arranged around the main region 1310A, and a plurality of first outer current collector layers 1324 and a plurality of second outer current collector layers 1326, which are provided on side surfaces of the first and the second peripheral regions 13106 and 1310C. The main region 1030A may have a rectangular shape, but may have a geometrically different shape.

The plurality of first peripheral regions 1310B may be provided in all directions of the main region 1310A, and the plurality of second peripheral regions 1310C may also be provided in all directions of the main region 1310A. In an embodiment, each of the first and the second peripheral regions 13106 and 1310C may exist on a left side of the main region 1310A. Each of the first and the second peripheral regions 13106 and 1310C may be also present on a right side of the main region 1310A. Each of the first and the second peripheral regions 1310B and 1310C may also exist on an upper side of the main region 1310A. Each of the first and the second peripheral regions 1310B and 1310C may also be present below the main region 1310A. On each side surface of the main region 1310A, the first and the second peripheral regions 13106 and 1310C cover the boundary of the main region 1310A and are provided adjacent to each other, but do not contact each other. Thicknesses 3T1 and 3T2 of the first and the second peripheral regions 13106 and 1310C provided at the respective side surfaces of the main region 1310A may be the same or substantially the same, and widths 3W1 and 3W2 may also be the same or substantially the same, but as described below, may be different from each other.

The first outer current collector layer 1324 is formed on a first side surface 13S1 of the first peripheral region 1310B present in each side surface of the main region 1310A. The first side surface 1351 may be parallel to or substantially parallel to the X-Z plane or the Y-Z plane depending on the position where the first peripheral region 1310B is provided. The first outer current collector layer 1324 may cover at least a part of the first side surface 13S1 and may be in direct contact with at least the part of the first side surface 13S1. In an embodiment, the first outer current collector layer 1324 may be in contact with an entire first side surface 13S1.

The second outer current collector layer 1326 is provided on a second side surface 13S2 of the second peripheral region 1310C present in each side surface of the main region 1310A. The second side surface 13S2 may be parallel to or substantially parallel to the adjacent first side surface 13S1. The second outer current collector layer 1326 may cover at least a part of the second side surface 13S2 and may be in direct contact with at least the part of the second side surface 13S2. In an embodiment, the second outer current collector layer 1326 may be in contact with an entire second side surface 13S2.

The first peripheral region 1310B may be a region connecting the main region 1310A with the first outer current collector layer 1324. The second peripheral region 1310C may be a region connecting the main region 1310A with the second outer current collector layer 1326.

An area in which the first outer current collector layer 1324 and the first peripheral region 13106 are in contact with each side surface of the main region 1310A may be the same as or substantially the same as the area in which the second outer current collector layer 1326 and the second peripheral region 1310C are in contact with each other.

In an embodiment, features and limitations associated with thicknesses of the first and the second outer current collector layers 1324 and 1326 and thicknesses of 3T1 and 3T2 of the first and the second peripheral regions 1310B and 1310C and widths of the main region 1310A may be similar to the features and limitations associated with thicknesses of the first and the second outer current collector layers 124 and 126 of the first multi-layer ceramic battery 110 and widths of the first and the second peripheral regions 1106 and 110C and the width of the main region 110A.

Referring to FIGS. 14 and 15, in the fifth multi-layer ceramic battery 1310, a unit battery UC5 includes a first electrode layer 1314, an all-solid electrolyte layer 150, and a second electrode layer 1316, which are sequentially stacked.

The fifth multi-layer ceramic battery 1310 includes a plurality of unit batteries UC5, which are vertically stacked. One of the first and the second electrode layers 1314 and 1316 is a cathode layer, and the other is an anode layer. In an embodiment, thicknesses of the first and the second electrode layers 1314 and 1316 may be the same or substantially the same as each other, but may be different from each other. In an embodiment, lengths of the first and the second electrode layers 1314 and 1316 in the horizontal direction or the first direction (e.g., the X-axis direction) may be the same or substantially the same as each other, but may be different from each other. When the first and the second electrode layers 1314 and 1316 have different lengths in the first direction, thicknesses 3T1 and 3T2 of the first and the second peripheral regions 1310B and 1310C in the first direction may be different from each other. Sizes of the first and the second peripheral regions 1310B and 1310C may affect the energy density of the battery. Therefore, in the process of setting or designing the first and the second peripheral regions 1310B and 1310C, the first and the second peripheral regions 1310B and 1310C may be designed in a direction in which energy density reduction of the battery is minimized. In an embodiment, when the battery energy density decreases as the first and the second peripheral regions 1310B and 1310C are provided, the first and the second peripheral regions 1310B and 1310C may be set or designed such that the energy density decrease is about 5% or less, about 4% or less, or about 3% or less, or about 0.1% to about 5%.

The first electrode layer 1314 may include a first part 94A belonging to the main region 1310A and a second part 94B belonging to the first peripheral region 1310B. The second electrode layer 1316 may include a first part 96A belonging to the main region 1310A and a second part 96B belonging to the second peripheral region 1310C. The all-solid electrolyte layer 150 may be included in all of the main region 1310A and the first and the second peripheral regions 1310B and 1310C.

In the main region 1310A, the first parts 94A and 96A of the first and the second electrode layers 1314 and 1316 are sequentially and alternately stacked two or more times. The space between the first parts 94A and 96A are filled with the all-solid electrolyte layer 150.

The first peripheral region 1310B may include a second part 94B of the first electrode layer 1314 and the all-solid electrolyte layer 150. In the first peripheral region 1310B, the second part 94B and the all-solid electrolyte layer 150 may be alternately stacked two or more times in a vertical direction. The first peripheral region 1310B does not include the second electrode layer 1316. Therefore, a first side surface 13S1 of the first peripheral region 1310B includes a side surface of the first electrode layer 1314, that is, a side surface of the second part 94B and a side surface of the all-solid electrolyte layer 150, and is spaced apart from the second electrode layer 1316.

The first outer current collector layer 1324 may cover an entire side surface of the first electrode layer 1314 and an entire side surface of the all-solid electrolyte layer 150 on the first side surface 13S1, and may be in direct contact with both side surfaces.

The second peripheral region 1310C includes the second part 96B of the second electrode layer 1316 and the all-solid electrolyte layer 150, and does not include the first electrode layer 1314. In the second peripheral region 1310C, the second part 96B and the all-solid electrolyte layer 150 may be alternately stacked two or more times in a vertical direction. A second side surface 13S2 of the second peripheral region 1310C includes a side surface of the second electrode layer 1316, that is, a side surface of the second part 96B and a side surface of the all-solid electrolyte layer 150, and is spaced apart from the first electrode layer 1314. The second outer current collector layer 1326 may cover an entire side surface of the second electrode layer 1316 and an entire side surface of the all-solid electrolyte layer 150 on the second side surface 13S2, and may be in direct contact with the side surface of the second electrode layer 1316 and the side surface of the all-solid electrolyte layer 150.

In an embodiment, a conductivity of the first electrode layer 1314 and a conductivity of the second electrode layer 1316 may be the same or substantially the same, or may be the same within a set range. In an embodiment, the first and the second electrode layers 1314 and 1316 may be single-layers, and at least one electrode layer may be a multi-layer. In an embodiment, materials of the first and the second electrode layers 1314 and 1316 may be different from each other. In an embodiment, in order to exhibit substantially equal conductivities of the first and the second electrode layers 1314 and 1316, the first and the second electrode layers 1314 and 1316 may have different layer configurations, or an additive for controlling conductivity may be added to at least one of the first and the second electrode layers 1314 and 1316. Accordingly, a contact area between the first peripheral region 1310B and the first outer current collector layer 1324 may be equal to or substantially the same as a contact area between the second peripheral region 1310C and the second outer current collector layer 1326.

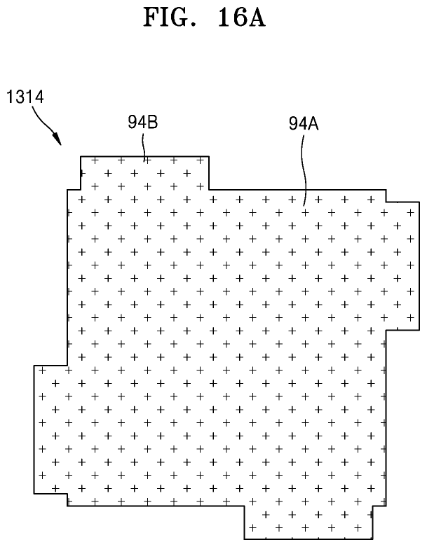

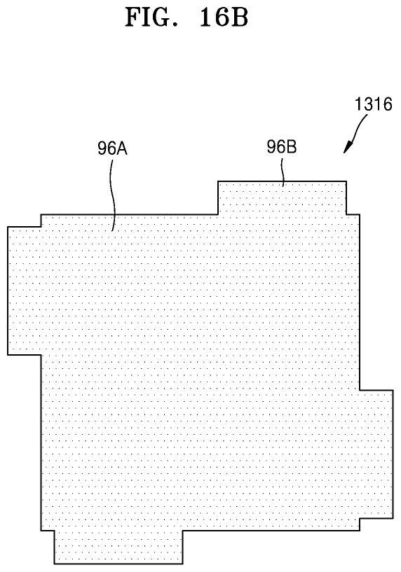

FIGS. 16A and 16B are plan views respectively illustrating examples of first and the second electrode layers 1314 and 1316 of the fifth stacked battery 1310. FIG. 16A is a plan view of the first electrode layer 1310, and FIG. 16B is a plan view of the second electrode layer 1316.

Referring to FIGS. 16A and 16B together, the first and the second electrode layers 1314 and 1316 may have a bilaterally symmetrical structure. The first electrode layer 1314 includes a rectangular first part 94A and four second parts 94B connected to the first part 94A. One of the second parts 94B may exist on each side surface of the first part 94A. The second parts 94B may be expressed as parts protruding from the first part 94A. The second part 94B on each side surface of the first part 94A is located between the center and the edge of the side surface. The four second parts 94B may have rotational symmetry.

The second electrode layer 1316 may include a rectangular first part 96A and four second parts 96B connected to the first part 96A. One of the second parts 96B may exist on each side surface of the first part 96A. The second parts 96B may be expressed as parts protruding from the first part 96A. The second part 96B on each side surface of the first part 96A may be positioned between the center and the edge of the side surface. The four second parts 96B may have rotational symmetry. The second part 94B of the first electrode layer 1314 and the second part 96B of the second electrode layer 1316 may be provided to be mirror-like to each other so as to be bilaterally symmetrical.

The multi-layer ceramic batteries described above may be deformed into various forms or various structures through some modifications of a structure or addition, deletion, or deformation of components.

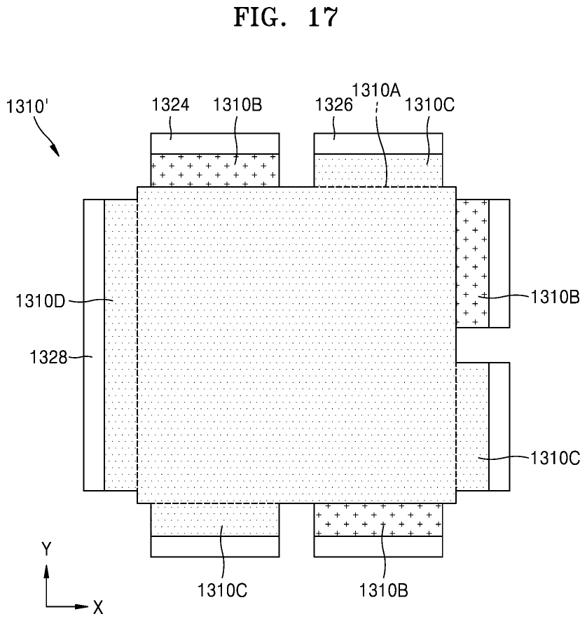

In an embodiment, in the case of the fifth multi-layer battery 1310, peripheral regions and/or outer current collector layers arranged around the main region 1310A may be deformed. For example, as illustrated in FIG. 17, the first and the second peripheral regions 13106 and 1310C arranged on other parts of the circumference of the main region 1310A may be maintained in the same manner as in FIG. 13, and only one of a third peripheral region 1310D may be arranged on a left side of the main region 1310A. A third outer current collector layer 1328 is provided on a third side surface 13S3 of the third peripheral region 1310D. The third outer current collector layer 1328 may cover an entire third side surface 13S3 of the third peripheral region 1310D and may be in direct contact with the third side surface 13S3. A size of the third peripheral region 1310D may be larger than those of the first and the second peripheral regions 13106 and 1310C. Only the size of the third peripheral region 1310D is different from that of the second peripheral region 1310C, and a layer configuration and a role of the former may be the same as those of the latter. The third outer current collector layer 1328 only differs in size from the second outer current collector layer 1326, and a material and a role of the third outer current collector layer 1328 may be the same as those of the second outer current collector layer 1326.

In a modified example 1310′ of the fifth multi-layer ceramic battery 1310 shown in FIG. 17, a conductivity of the second electrode layer 1316 included in the second and the third peripheral regions 1310C and 1310D may be less than that of the first electrode layer 1314 included in the first peripheral region 1310B.

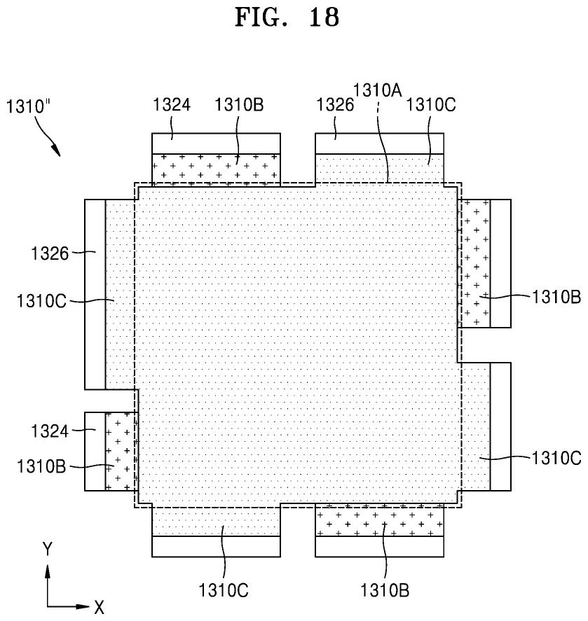

In an embodiment, the fifth multi-layer ceramic battery 1310 may be deformed as shown in FIG. 18.

Referring to a modified example 1310″ of the fifth multi-layer ceramic battery 1310 illustrated in FIG. 18, the modified example 1310″ is the same as the fifth multi-layer ceramic battery 1310 in that one of the first peripheral region 13106 and one of the second peripheral region 1310C are provided on each side surface of the main region 1310A. However, sizes of the first and the second peripheral regions 13106 and 1310C arranged on one of the side surfaces of the main region 1310A may be different from each other, and the sizes of the first and the second peripheral regions 13106 and 1310C arranged on the other side surfaces may be the same.

When the first and the second peripheral regions 1310B and 1310C arranged on the one of the side surfaces of the main region 1310A have different sizes, for example, the first peripheral region 13106 may have a size less than that of the second peripheral region 1310C, and the size of the first outer current collector layer 1324 may be less than that of the second outer current collector layer 1326. In this case, a conductivity of the second electrode layer 1316 partially included in the second peripheral region 1310C may be less than that of the first electrode layer 1314 partially included in the first peripheral region 1310B. In other words, a conductivity of the first electrode layer 1314 may be greater than that of the second electrode layer 1316.

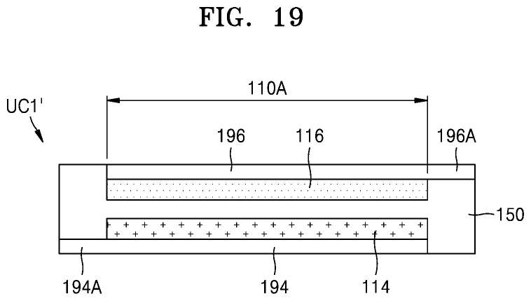

In an embodiment, in the first multi-layer ceramic battery 110 described above, the unit battery UC1 may be replaced with a unit battery UC1′ illustrated in FIG. 19.

Referring to FIG. 19, a first inner current collector layer 194 may be provided on a bottom surface of the first electrode layer 114, and a second inner current collector layer 196 may be provided on the second electrode layer 116. The first inner current collector layer 194 may include a part 194A belonging to the first peripheral region 1106, and the second inner current collector layer 196 may include a part 196A belonging to the second peripheral region 110C.

When the first multi-layer ceramic battery 110 includes a unit battery UC1′ of FIG. 19, the first and the second electrode layers 114 and 116 may be present only in the main region 110A and may not be present in the first and the second peripheral regions 1106 and 110C. Therefore, the first peripheral region 1106 may include the part 194A of the first inner current collector layer 194 and the all-solid electrolyte layer 150, and may not include the second inner current collector layer 196. In addition, the second peripheral region 110C may include the part 196A of the second inner current collector layer 196 and the all-solid electrolyte layer 150, and may not include the first inner current collector layer 194. Accordingly, the first outer current collector layer 124 in contact with the first peripheral region 1106 may be in direct contact with the first inner current collector layer 194 on a side surface of the first peripheral region 1106. In addition, the second outer current collector layer 126 in contact with the second peripheral region 110C may be in direct contact with the second inner current collector layer 196 on the side surface of the second peripheral region 110C. In an embodiment, materials of the first and the second inner current collector layers 194 and 196 may be the same or different from each other. In an embodiment, conductivities of the first and the second outer current collector layers 124 and 126 may be equal to or greater than conductivities of the first and the second inner current collector layers 194 and 196. Materials satisfying the conditions may be selected as materials of the first and the second outer current collector layers 124 and 126 and materials of the first and the second inner current collector layers 194 and 196.

The unit battery UC1′ shown in FIG. 19 may also be applied to the second to fifth multi-layer ceramic batteries 410, 710, 1010, and 1310 described above. That is, the unit battery UC1′ of FIG. 19 may be used as the unit battery of each of the second to fifth multi-layer ceramic batteries 410, 710, 1010, and 1310.

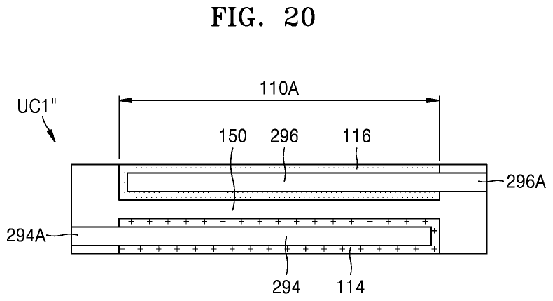

In an embodiment, in the first multi-layer ceramic battery 110 described above, the unit battery UC1 may be replaced with a unit battery UC1″ illustrated in FIG. 20.

Referring to FIG. 20, the first electrode layer 114 may include a first inner current collector layer 294, and the second electrode layer 116 may include a second inner current collector layer 296. A part of the first inner current collector layer 294 (a part belonging to the main region 110A) may be viewed as a shape being embedded in the first electrode layer 114, and may be viewed as the first electrode layer 114 provided (e.g., coated, or disposed) on both surfaces of the part of the first inner current collector layer 294 (the part belonging to the main region 110A). A part of the second inner current collector layer 296 may also be viewed as a shape being embedded in the second electrode layer 116, and in an aspect, may be viewed as the second electrode layer 116 provided (e.g., coated, or disposed) on both surfaces of the part of the second inner current collector layer 296 (the part belonging to the main region 110A). The first inner current collector layer 294 includes a part 294A belonging to the first peripheral region 1106, and the first electrode layer 114 is not present in this part 294A. The second inner current collector layer 296 includes a part 296A belonging to the second peripheral region 110C, and the second electrode layer 116 is not present in this part 296A.

When the first multi-layer ceramic battery 110 includes the unit battery UC1″ of FIG. 20, the first and the second electrode layers 114 and 116 may be present only in the main region 110A and may not be present in the first and the second peripheral regions 1106 and 110C.

Therefore, the first peripheral region 1106 may include the part 294A of the first inner current collector layer 294 and the all-solid electrolyte layer 150, and may not include the second inner current collector layer 296. In addition, the second peripheral region 110C may include the part 296A of the second inner current collector layer 296 and the all-solid electrolyte layer 150, and may not include the first inner current collector layer 294. Accordingly, the first outer current collector layer 124 in contact with the first peripheral region 1106 may be in direct contact with the first inner current collector layer 294 on a side surface of the first peripheral region 1106. In addition, the second outer current collector layer 126 in contact with the second peripheral region 110C may be in direct contact with the second inner current collector layer 296 on a side surface of the second peripheral region 110C. In an embodiment, materials of the first and the second inner current collector layers 294 and 296 may be the same or different from each other. In an embodiment, conductivities of the first and the second outer current collector layers 124 and 126 may be equal to or greater than conductivities of the first and the second inner current collector layers 294 and 296. Materials satisfying the conductivity conditions may be selected as materials of the first and the second outer current collector layers 124 and 126 and materials of the first and the second inner current collector layers 294 and 296. The unit battery UC1″ shown in FIG. 20 may also be used as the unit battery for each of the second to fifth multi-layer ceramic batteries 410, 710, 1010, and 1310 described above.

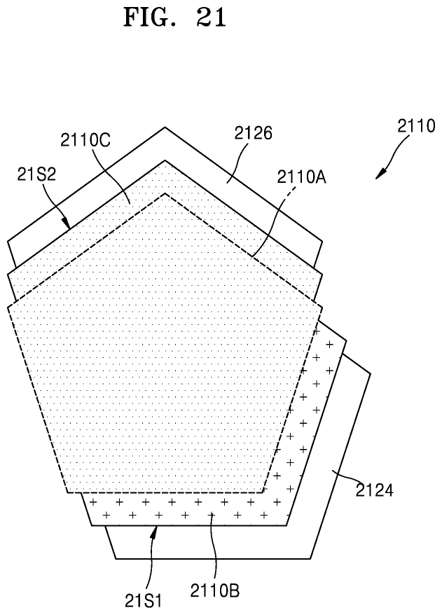

FIG. 21 is a plan view of a sixth multi-layer ceramic battery 2110 including an all-solid electrolyte according to an embodiment.

Referring to FIG. 21, the sixth multi-layer ceramic battery 2110 includes a pentagonal main region 2110A, and first and second peripheral regions 2110B and 2110C and first and second outer current collector layers 2124 and 2126, which are arranged around the pentagonal main region 2110A. The first peripheral region 2110B may be provided to cover two adjacent side surfaces of the main region 2110A, and the second peripheral region 2110C may be provided to cover two other adjacent side surfaces of the main region 2110A. The first and the second peripheral regions 2110B and 2110C are spaced apart from each other. One of the first and the second peripheral regions 2110B and 2110C may be provided to cover two or more consecutive side surfaces of the main region 2110A. The first peripheral region 21106 may include a stack or a layer configuration corresponding to the first peripheral region 1106 of the first multi-layer ceramic battery 110. The second peripheral region 2110C may include a stack or a layer configuration corresponding to the second peripheral region 110C of the first multi-layer ceramic battery 110. The first outer current collector layer 2124 is provided on a side surface 21S1 of the first peripheral region 2110B, and the second outer current collector layer 2126 is provided on a side surface 21S2 of the second peripheral region 2110C. The side surface 21S1 of the first peripheral region 2110B may have an external shape similar to two adjacent side surfaces of the corresponding main region 2110A. The first outer current collector layer 2124 may be provided along the side surface 21S1 and may be in direct contact with the side surface 21S1. The side surface 21S2 of the second peripheral region 2110C may have an external shape similar to two adjacent side surfaces of the corresponding main region 2110A. The second outer current collector layer 2126 may be provided along the side surface 21S2 and may be in direct contact with the side surface 21S1.

The inner layer structure of the sixth multi-layer ceramic battery 2110 may be the same as any one of the first to fifth multi-layer ceramic batteries 110, 410, 710, 1010, and 1310. The unit batteries UC1′ and UC1″ of FIGS. 19 and 20 may also be applied to the sixth multi-layer ceramic battery 2110. That is, one of the unit batteries UC1′ and UC1″ shown in FIGS. 19 and 20 may be used as a unit battery for the sixth multi-layer ceramic battery 2110.

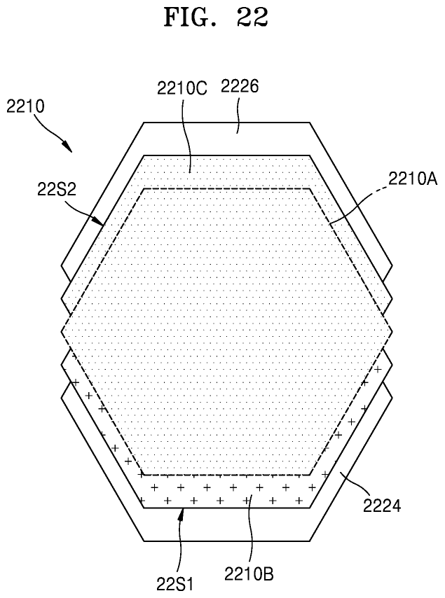

FIG. 22 is a plan view of a seventh multi-layer ceramic battery 2210 including an all-solid electrolyte according to an embodiment.

Referring to FIG. 22, the seventh multi-layer battery 2210 includes a main region 2210A having a hexagonal shape, first and second peripheral regions 2210B and 2210C arranged around the main region 2210A, and first and second external current collector layers 2224 and 2226 when viewed in a plan view. The first peripheral region 2210B is provided to cover three adjacent side surfaces of the main region 2210A, and the second peripheral region 2210C is provided to cover three other adjacent side surfaces of the main region 2210A. The first and second peripheral regions 22106 and 2210C are spaced apart from each other. One of the first and second peripheral regions 22106 and 2210C may be provided to cover two or more consecutive side surfaces of the main region 2110A. The first peripheral region 2110B may include a stack or a layer configuration corresponding to the first peripheral region 1106 of the first multi-layer ceramic battery 110. The second peripheral region 2110C may include a stack or a layer configuration corresponding to the second peripheral region 110C of the first multi-layer ceramic battery 110. The first outer current collector layer 2224 is provided on each of three side surfaces 22S1 of the first peripheral region 2210B, and the second outer current collector layer 2226 is provided on each of three side surfaces 22S2 of the second peripheral region 2210C. The side surfaces 22S1 of the first auxiliary region 2210B may have an appearance similar to three adjacent side surfaces of the corresponding main region 2210A, and the first outer current collector layer 2224 may be provided along the three side surfaces 22S1 and may be in direct contact with the three side surfaces 22S1. The three side surfaces 22S2 of the second auxiliary region 2210C may have an appearance similar to three adjacent side surfaces of the corresponding main region 2210A, and the second outer current collector layer 2226 may be provided along the three side surfaces 22S2 and may be in direct contact with the three side surfaces 22S2.

The inner layer structure of the seventh multi-layer ceramic battery 2210 may be the same as any one of the first to fifth multi-layer ceramic batteries 110, 410, 710, 1010, and 1310. The unit batteries UC1′ and UC1″ of FIGS. 19 and 20 may also be applied to the seventh multi-layer ceramic battery 2210.

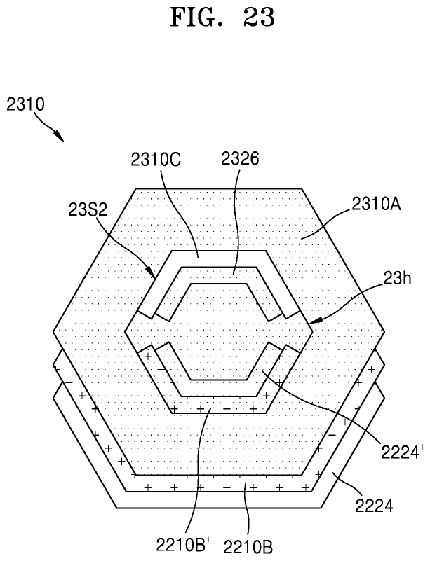

FIG. 23 is a plan view of an eighth multi-layer ceramic battery 2310 including an all-solid electrolyte according to an embodiment.

Referring to FIG. 23, the eighth multi-layer ceramic battery 2310 may be considered as a modified example of the seventh multi-layer ceramic battery 2210 of FIG. 22. Specifically, the eighth multi-layer ceramic battery 2310 includes a through hole 23h penetrating the main region 2310A at the center of the hexagonal main region 2310A. A second auxiliary region 2310C is provided in the through hole 23h, and a second external current collector layer 2326 is provided on an inner surface of the second auxiliary region 2310C.

Since the second auxiliary region 2310C is an extended part of the second electrode layer of the main region 2310A, the planar shape of the through hole 23h may not be seen as a complete hexagon. However, for convenience, the through hole 23h is a hexagonal through hole penetrating the main region 2310A, and the second auxiliary region 2310C may be regarded as an extended part inside the through hole 23h. Accordingly, the boundary of the hexagonal through hole 23h may be a boundary of the inner surface 23S2 of the main region 2310A. The second auxiliary region 2310C may be provided to cover three adjacent side surfaces of the inner surface 23S2 of the main region 2310A, and the second outer current collector layer 2326 may be provided on three side surfaces of the inner surface of the second auxiliary region 2310C.

The remaining configuration of the eighth multi-layer ceramic battery 2310 may be the same as those of the seventh multi-layer ceramic battery 2210, but as indicated by reference numerals 2210B′ and 2224′, the first auxiliary region 2210B′ and the first outer current collector layer 2224′ may also be provided in the through hole 23h. The first auxiliary region 2210B′ and the first outer current collector layer 2224′ are spaced apart from the second auxiliary region 2310C and the second outer current collector layer 2326 in the through hole 23h. For example, the first and second auxiliary regions 2210B′ and 2310C may be provided to be symmetrical in the through hole 23h, and the first and second outer current collector layers 2224′ and 2326 may also be provided to be symmetrical.

The inner layer structure of the eighth multi-layer ceramic battery 2210 may be the same as any one of the first to fifth multi-layer ceramic batteries 110, 410, 710, 1010, and 1310. In addition, the unit batteries UC1′ and UC1″ of FIGS. 19 and 20 may also be applied to the eighth multi-layer ceramic battery 2310.

In addition, when a through hole 23h having a plurality of side surfaces is formed in the main area 2310A like the eighth multi-layer ceramic battery 2310, the inventive concept may be applied to other multi-layer ceramic batteries.

The multi-layer ceramic battery according to an embodiment described above is a secondary battery and may be applied to various devices using a battery as a power source. Here, the device may include an electronic device.

In an embodiment, one of the first to eighth multi-layer ceramic batteries 110, 410, 710, 1010, 1310, 2110, 2210, and 2310 described above may be mounted on an electronic device, such as a smartphone, wearable device (e.g., watch, band, lighting, bio-signal detector, earphone, headset, or sound device), an augmented reality (AR) and virtual reality (VR) device, an Internet of Things (IoT) device, home appliance, tablet Personal computer (PC), personal digital assistant (PDA), portable multimedia player (PMP), a navigation device, a drone, a robot, an unmanned vehicle, an autonomous vehicle, or an advanced drivers assistance system (ADAS), but is not limited thereto.

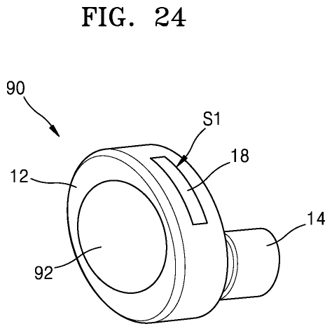

FIG. 24 illustrates a battery-replaceable wireless earbuds as an example of an electronic device including a secondary battery according to an embodiment.

Referring to FIG. 24, an earbud 90 includes a body 12 and an insertion part 14 connected thereto. The body 12 may include a circuit board that supports the operation of the earbud 90 and manages a battery. The insertion part 14 has a structure protruding by a first length in a given direction from the surface of the body 12, and is a part inserted into the ear of a wearer of the earbud 90. The first length may be determined in consideration of the depth of the wearer's ear. A slot S1 is formed in the body 12. An inlet of the slot S1 may be formed on the surface of the body 12. A battery 18 is inserted into the slot S1. The battery 18 may be a secondary battery that may be charged and repeatedly used. In an embodiment, the battery 18 may include one of the first to eighth multi-layer ceramic batteries 110, 410, 710, 1010, 1310, 2110, 2210, and 2310 and various modifications. The battery 18 may be a coin type or a prismatic secondary battery. The slot S1 may have a rectangular shape, but may have a shape corresponding to the shape of the battery 18, that is, a shape optimized for mounting the battery 18.

Reference numeral 92 is a switch (operation button) that turns on and off the operation of the earbud. Switch 92 may be operated in a touch manner including a touch sensor.

The earbud 90 may be a wireless earphone and may be an AirPod.

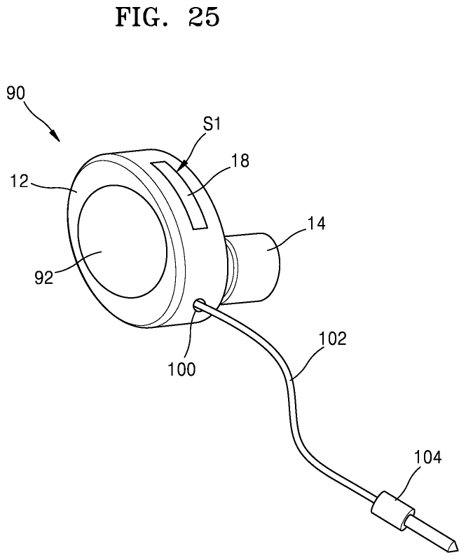

In an embodiment, as shown in FIG. 25, the earbud 90 may further include a connection cable 102 and be used for both wired and wireless purposes. The connection cable 102 connects the earbud 90 to an external device (not shown). The external device may be a device that provides voice information or a voice signal to be heard through the earbud 90. For example, the external device may be a mobile device, an image supply medium, or a radio.

One end of the cable 102 may be connected to the earbud 90. A jack 104 is attached to the other end of the cable 102. The jack 104 may be inserted into an insertion hole provided in the external device. The earbud 90 may have a groove 100 for connecting the cable 102 at a part where one end of the cable 102 is connected to the body 12. The cable 102 may be permanently connected to the body 12 through the groove 100, but a jack may be provided at one end of the cable 102 similar to the other end and inserted into the groove 100. In the latter case, the cable 102 may be separated from the earbud 90 and the external device. Therefore, when the cable 102 is not required as in the outdoors, the earbud 90 may be used as a wireless earbud that does not use the cable 102. When indoors, by using the earbud 90 in a wired manner by using the cable 102, the battery may stand by in a charged state.

The above-described earbud shows only one of the two paired earbuds, for example, the earbud for the user's left ear. The configuration of the earbud for the user's right ear may also be the same as that of the earbud for the user's left ear.

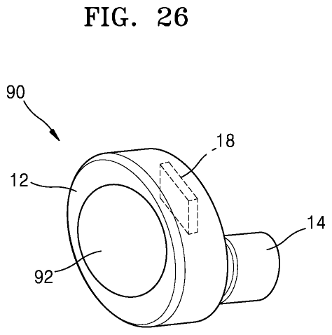

In the earbuds 90 of FIGS. 24 and 25, the slot S1 may be an optional configuration. For example, the earbud 90 may not have the slot S1 as shown in FIG. 26, and the battery 18 may be provided in a form embedded in the body 12.

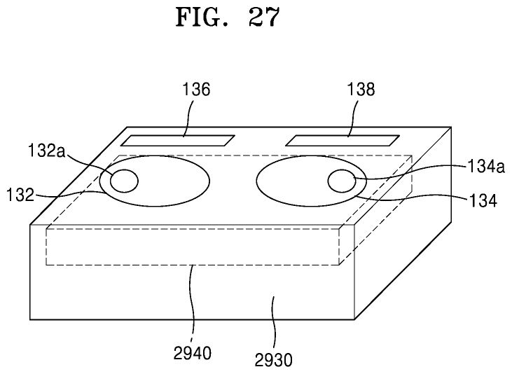

FIG. 27 illustrates a case for storing and charging the battery replacement earbuds.

Referring to FIG. 27, first and second grooves 132 and 134 are formed on an upper surface of the case 2930. Earbuds may be mounted in the first and the second grooves 132 and 134, respectively. In an embodiment, a third groove 132a deeper than the first groove 132 may be formed in the first groove 132. In an embodiment, a fourth groove 134a deeper than the second groove 134 may be formed in the second groove 134. The third and the fourth grooves 132a and 134a may be grooves into which the insertion part 14 of the earbud 90 shown in FIGS. 24, 25, and 26 is inserted. In an embodiment, the third and the fourth grooves 132a and 134a may be through holes. In an embodiment, first and second slots 136 and 138 may be provided on an upper surface of the case 2930. The first and the second slots 136 and 138 may be arranged adjacent to each other corresponding to the first and the second grooves 132 and 134, respectively. The first and the second slots 136 and 138 may be slots for charging batteries.

In an embodiment, while storing the earbuds in the first and the second grooves 132 and 134, the batteries may be inserted into and charged in the first and the second slots 136 and 138. A large-capacity power supply source 2940 may be disposed (e.g., arranged) inside the case 2930. The batteries inserted into the first and the second slots 136 and 138 may be charged from the large-capacity power supply source 2940. In an embodiment, the large-capacity power supply source 2940 may be a large-capacity battery having a capacity that is larger than a capacity of the battery inserted into the first and the second slots 136 and 138, or may include such a large-capacity battery.

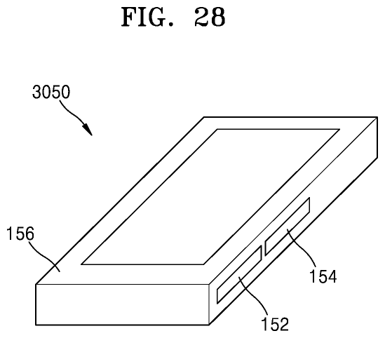

FIG. 28 illustrates a mobile device for the earbuds illustrated in FIG. 24.

Referring to FIG. 28, a mobile device 3050 compatible with the earbuds may be a mobile device optimized for the earbuds. The mobile device 3050 may be a mobile phone or another portable image providing device. The mobile device 3050 may include a body 156 having at least a terminal for outputting a voice signal (voice information) and/or an image signal (image information) and first and second slots 152 and 154 on a side of the body 156. The first and the second slots 152 and 154 may be slots for charging replacement batteries for the earbuds. The charging power of the batteries may be supplied from the power of the mobile device 3050.

A multi-layer ceramic battery including the disclosed all-solid electrolyte layer includes current collectors on at least three side surfaces around the battery stack. Since the current collector is widely expanded to three or more sides, current distribution uniformity of the entire current collector may be increased, and thus problems (for example, deterioration) due to current concentration in a specific region of the current collector may be minimized or eliminated, thereby securing battery stability and implementing high-speed charging.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A multi-layer ceramic battery comprising:
a main region in which charging and discharging is performed;
a peripheral region positioned around the main region; and
a plurality of outer current collector layers disposed on a side surface of the peripheral region, wherein each outer current collector layer of the plurality of outer current collector layers is spaced apart from one another, wherein
the peripheral region comprises a stack, which comprises at least three side surfaces, is in contact with the outer current collector layers, and is connected to the main region, and
the plurality of outer current collector layers is disposed on the at least three side surfaces.

2. The multi-layer ceramic battery of claim 1, wherein the plurality of outer current collector layers comprise
a first outer current collector layer, and
a second outer current collector layer spaced apart from the first outer current collector layer,
wherein the first outer current collector layer is disposed on at least one of the at least three side surfaces, and the second outer current collector layer is disposed on remaining side surfaces of the at least three side surfaces.

3. The multi-layer ceramic battery of claim 1, wherein the plurality of outer current collector layers is symmetrically arranged around the main region.

4. The multi-layer ceramic battery of claim 1, wherein the plurality of outer current collector layers is asymmetrically arranged around the main region.

5. The multi-layer ceramic battery of claim 1, wherein the peripheral region is symmetrical around the main region.

6. The multi-layer ceramic battery of claim 1, wherein the peripheral region is asymmetrical around the main region.

7. The multi-layer ceramic battery of claim 1, wherein the main region comprises
a first electrode layer;
a second electrode layer facing the first electrode layer; and
an all-solid electrolyte layer disposed between the first electrode layer and the second electrode layer.

8. The multi-layer ceramic battery of claim 7, wherein the peripheral region comprises
a first peripheral region comprising the first electrode layer and the all-solid electrolyte layer, and not comprising the second electrode layer, and
a second peripheral region comprising the second electrode layer and the all-solid electrolyte layer, and not comprising the first electrode layer,
wherein the first and the second peripheral regions are spaced apart from each other.

9. The multi-layer ceramic battery of claim 8, wherein the first and the second peripheral regions are located on a same side of the main region and are spaced apart from each other.

10. The multi-layer ceramic battery of claim 7, wherein at least one of the first electrode layer or the second electrode layer comprises a part, which extends to the peripheral region in three different directions.

11. The multi-layer ceramic battery of claim 10, wherein a second part of the first electrode layer extends in three different directions, and a second part of the second electrode layer extends in three different directions, and the first electrode layer and the second electrode layer are bilaterally symmetrical to each other in a plan view.

12. The multi-layer ceramic battery of claim 10, wherein a first part of the first electrode layer extends in four different directions, and a first part of the second electrode layer extends in four different directions, and wherein the first electrode layer and the second electrode layer are bilaterally symmetrical to each other in a plan view.

13. The multi-layer ceramic battery of claim 7, further comprising a first inner current collector layer connected to one of an outer current collector layer of the plurality of outer current collector layers on a first surface of one of the first or the second electrode layers.

14. The multi-layer ceramic battery of claim 13, further comprising a second inner current collector layer connected to an other outer current collector layer of the plurality of outer current collector layers on a second surface of an other of the first or the second electrode layers.

15. The multi-layer ceramic battery of claim 7, further comprising a first inner current collector layer connected to one of an outer current collector layer of the plurality of outer current collector layers, wherein one of the first or the second electrode layers is disposed on both surfaces of the first inner current collector layer.

16. The multi-layer ceramic battery of claim 15, further comprising a second inner current collector layer connected to an other outer current collector layer of the plurality of outer current collector layers, wherein an other of the first or the second electrode layers is disposed on both surfaces of the second inner current collector layer.

17. An electronic device comprising
A battery; and
a control unit configured to control an operation of the electronic device,
wherein the battery comprises the multi-layer ceramic battery of claim 1.

18. The electronic device of claim 17, wherein the electronic device comprises a wearable device.
